(19) United States
(12) Patent Application Publication
(10) Pub. No.: US 2014/0258918 A1
(43) Pub. Date: Sep. 11, 2014

(54) MEDICAL INFORMATION DISPLAYING APPARATUS

(71) Applicants: Kabushiki Kaisha Toshiba, Minato-ku (JP); Toshiba Medical Systems Corporation, Otawara-shi (JP)

(72) Inventors: Hiroshizu MORISHIMA, Utsunomiya-shi (JP); Maki Minakuchi, Utsunomiya-shi (JP)

(73) Assignees: Kabushiki Kaisha Toshiba, Minato-ku (JP); Toshiba Medical Systems Corporation, Otawara-shi (JP)

(21) Appl. No.: 14/253,245

(22) Filed: Apr. 15, 2014

Related U.S. Application Data
(63) Continuation of application No. PCT/JP2013/056875, filed on Mar. 12, 2013.

(30) Foreign Application Priority Data
Mar. 12, 2012 (JP) 2012-054206

(51) Int. Cl. G06F 3/0481

(52) U.S. Cl. CPC G06F 3/0481
USPC 715/783; 715/790

(57) ABSTRACT

A medical information displaying apparatus is provided to facilitate efficiency in performing image interpretation and diagnostic process performed with windows being displayed. The apparatus comprises: display; display controller; first determiner; and adjuster. The display controller displays windows having predetermined display sizes. The first determiner determines, with at least first window displayed on display screen and if second window is additionally displayed on display screen, whether there is an area for displaying second window on display screen, based on a display area for first window and displaying conditions for second window. If no area is available for displaying second window, adjuster determines whether it is possible to make adjustment to displaying conditions of first window and/or second window so that first window and second window will be displayed on display screen, adjuster also configured to adjust displaying conditions if displaying conditions can be adjusted.

### CROSS-REFERENCE TO RELATED APPLICATIONS

This application is based upon and claims the benefit of priority from Japanese Patent Applications No. 2012-054206, filed on Mar. 12, 2012; the entire contents of all of which are incorporated herein by reference.

### FIELD

Embodiments relate to medical information displaying apparatuses.

### BACKGROUND

In the medical field, specialties are subdivided. For example, it is widely practiced that specialists (radiologists) are asked to make interpretations of medical images, which are acquired with medical imaging apparatuses (X-ray CT system, MRI system, etc.). While seeing a plurality of medical images, a radiologist may work to summarize findings as a diagnostic report.

Also, a physician at a clinical department does input work of electronic patient charts by referring to images acquired with a medical imaging apparatus, test results acquired with test equipment, and so on.

Recently, hospitals are introducing a system that is specialized for each of the specialties of medical examination. In the case where a radiologist creates a diagnostic report or in the case where a physician at a clinical department works to input electronic patient charts, medical information provided by the system used at each department is displayed in a plurality of windows on the display screen of a single terminal.

Here, each of the systems is specialized for each specialty of medical examination, and the systems are often arranged by different vendors. To refer to different pieces of medical information, an application dedicated for each of the systems is launched, and as a result, a plurality of windows are displayed.

### BRIEF DESCRIPTION OF THE DRAWINGS

FIG. 1 is a general view of a medical information system, which relates to a first embodiment.

FIG. 2 is a diagram showing an electronic patient chart apparatus as a first embodiment.

FIG. 3A is a drawing that shows an example of a display screen of the first embodiment.

FIG. 3B is a drawing that shows another example of a display screen of the first embodiment.

FIG. 3C is a drawing that shows yet another example of a display screen of the first embodiment.

FIG. 3D is a drawing that shows still another example of a display screen of the first embodiment.

FIG. 3E is a drawing that shows a further example of a display screen of the first embodiment.

FIG. 3F is a drawing that shows an example of a display screen of the first embodiment.

FIG. 3G is a drawing that shows another example of a display screen of the first embodiment.

FIG. 3H is a drawing that shows yet another example of a display screen of the first embodiment.

FIG. 3I is a drawing that shows still another example of a display screen of the first embodiment.

FIG. 3J is a drawing that shows a further example of a display screen of the first embodiment.

FIG. 4A is a diagram showing an example of table information for the first embodiment.

FIG. 4B is a diagram showing another example of table information for the first embodiment.

FIG. 5 is a flowchart showing actions taken by the electronic patient chart apparatus as the first embodiment.

FIG. 6 is a diagram showing an electronic patient chart apparatus as a second embodiment.

FIG. 7A is a drawing that shows an example of a display screen of the second embodiment.

FIG. 7B is a drawing that shows another example of a display screen of the second embodiment.

FIG. 7C is a drawing that shows yet another example of a display screen of the second embodiment.

FIG. 7D is a drawing that shows still another example of a display screen of the second embodiment.

FIG. 7E is a drawing that shows a further example of a display screen of the second embodiment.

FIG. 7F is a drawing that shows another example of a display screen of the second embodiment.

FIG. 7G is a drawing that shows yet another example of a display screen of the second embodiment.

FIG. 7H is a drawing that shows still another example of a display screen of the second embodiment.

FIG. 8 is a diagram showing an example of table information for the second embodiment.

FIG. 9 is a flowchart showing actions taken by the electronic patient chart apparatus as the second embodiment.

FIG. 10 is a diagram showing an electronic patient chart apparatus as a third embodiment.

FIG. 11A is a drawing that shows an example of a display screen of the third embodiment.

FIG. 11B is a drawing that shows another example of a display screen of the third embodiment.

FIG. 11C is a drawing that shows yet another example of a display screen of the third embodiment.

FIG. 11D is a drawing that shows still another example of a display screen of the third embodiment.

FIG. 12 is a flowchart showing actions taken by the electronic patient chart apparatus as the third embodiment.

FIG. 13 is a diagram showing an electronic patient chart apparatus as a fourth embodiment.

FIG. 14A is a drawing that shows an example of a display screen of the fourth embodiment.

FIG. 14B is a drawing that shows another example of a display screen of the fourth embodiment.

FIG. 15 is a flowchart showing actions taken by the electronic patient chart apparatus as the fourth embodiment.

FIG. 16 is a drawing showing an example of overlaid display.

FIG. 17 is a drawing showing a display size for a window that corresponds to a vacant area of the display screen and an example of medical information to be moved into the window.

FIG. 18 is a drawing showing a window opened in a vacant area of the display screen and an example of medical information being presented in a display area.

### DETAILED DESCRIPTION

Embodiments herein have been invented to solve the above-described problem, and their objective is to provide a medical information displaying apparatus that facilitates efficiency in performing image interpretation, diagnostic process, or the like, which is performed with a plurality of windows being displayed.

In order to solve the above-described problem, a medical information displaying apparatus of this embodiment comprises: a display; a display controller; a first determiner; and an adjuster.

The display controller is configured to display, on a display screen of the display, a plurality of windows, each of which has a predetermined display size. The first determiner is configured to determine, with at least a first window having been displayed on the display screen and if a second window is to be additionally displayed on the display screen, whether or not there is an area for displaying the second window on the display screen, based on a display area for the first window and in compliance with displaying conditions for the second window.

The adjuster is configured to determine, in response to the determination having resulted in that no area is available for displaying the second window, whether or not it is possible to make adjustment to the displaying conditions of the first window and/or the second window so that the first window and the second window will be displayed on the display screen, the adjuster also configured to adjust the displaying conditions if the determination has resulted in that the displaying conditions can be adjusted.

### First Embodiment

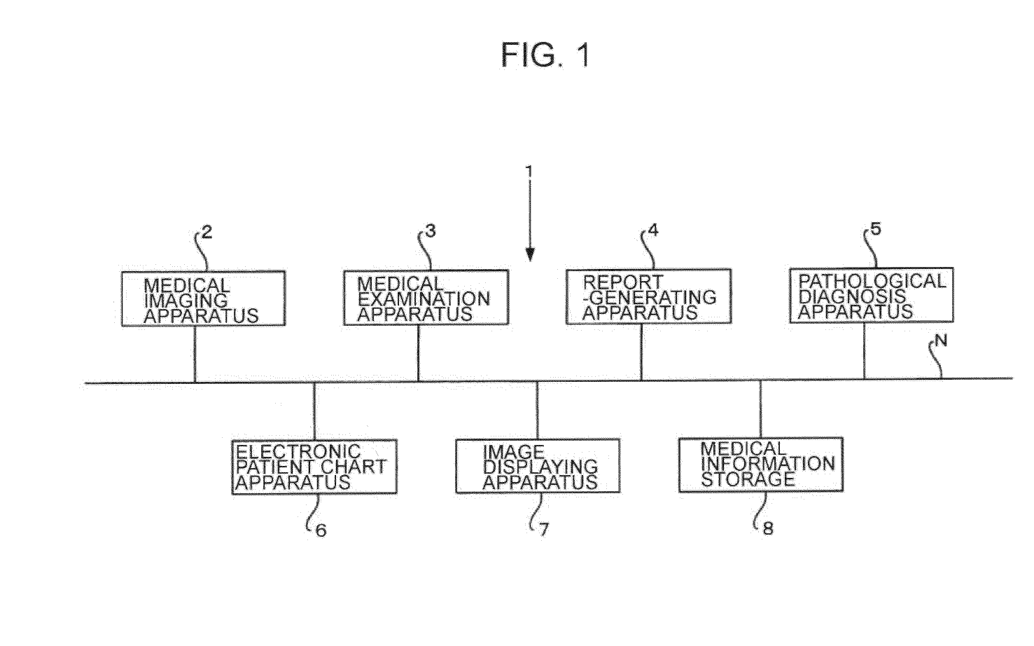

The configuration of a medical information displaying apparatus (a part of an electronic patient chart apparatus 6) as a present embodiment is described with reference to FIG. 1 through FIG. 5.

### [Entire Configuration of Medical Information System 1]

As shown in FIG. 1, a medical information system 1 is configured to include a medical imaging apparatus 2, a medical examination apparatus 3, a report-generating apparatus 4, a pathological diagnosis apparatus 5, an electronic patient chart apparatus 6, an image displaying apparatus 7, and a medical information storage 8. These constituent apparatuses and devices are in communication with one another through a network N, for example, a LAN (Local Area Network). It is desirable that the communication between the apparatuses and devices be based on DICOM (Digital Imaging and Communications in Medicine), which is a standard used for medical images. However, another standard may also be applied appropriately. Information communication is based on TCP/IP (Transmission Control Protocol/Internet Protocol), which is a local communications standard, and data are exchanged in packets (base units of information transfer) through the network N.

The medical imaging apparatus 2 comprises a plurality of imaging apparatuses such as an X-ray apparatus, an X-ray CT (Computed Tomography) apparatus, an MRI (Magnetic Resonance Imaging) apparatus, and an upper (or lower) tract endoscope device. Medical images are acquired by scanning subjects with these imaging apparatuses, and medical images acquired are in, for example, a file format that conforms with the DICOM and are transmitted to the medical information storage 8. Medical images being transmitted include their image-related information (identification information), which information is associated with the medical images, including patient ID, date of image acquisition, captured conditions, and so on. Incidentally, since the terms “image” and “image data” correspond to each other one-on-one, they may be used as identical terms for the present embodiment.

The medical examination apparatus 3 may be a blood analyzer and an electrocardiograph. Each apparatus is equipped with its dedicated application software for processing test results. The examination information acquired with these examination apparatuses is transmitted to the medical information storage 8, and examination information being transmitted includes such test-results-related information such as patient ID, date of examination, and examination conditions.

The report-generating apparatus 4 is an apparatus for generating a diagnostic report by recording the radiologist's findings about medical images that are displayed on its display screen, in accordance with instructions input by the radiologist. The report-generating apparatus 4 is a so-called “computer” and is configured to include a CPU (Central Processing Unit, not shown), ROM (Read Only Memory, not shown), RAM (Random Access Memory, not shown), and a display (not shown). The report-generating apparatus 4 executes predetermined processing under the control of its dedicated application software. Diagnostic reports created are transmitted to the medical information storage 8, and diagnostic reports include information such as patient ID.

The pathological diagnosis apparatus 5 is an apparatus used for performing pathological, diagnostic processes on medical images displayed on its display and also used for obtaining pathological, diagnostic information. The pathological diagnosis apparatus 5 is a so-called “computer” and is configured to include a CPU (not shown), ROM (not shown), RAM (not shown), and a display (not shown). The pathological diagnosis apparatus 5 executes predetermined processing under the control of its dedicated application software. Pathological, diagnostic information acquired is transmitted to the medical information storage 8, the pathological, diagnostic information including such information as patient ID.

The electronic patient chart apparatus 6 is an apparatus to electronically create and manage patient charts, which have been conventionally created directly by physicians, who fill out a form on paper. The electronic patient chart apparatus 6 is a so-called “computer” and is configured to include a CPU 62 (described later), ROM (not shown), RAM (not shown), and a display 63 (described later). The electronic patient chart apparatus 6 executes predetermined processing under the control of its dedicated application software. Electronic patient charts created are transmitted to the medical information storage 8, and electronic patient charts include information such as patient ID.

The image displaying apparatus 7 is an apparatus to display medical images. The image displaying apparatus 7 is a so-called “computer” and is configured to include a CPU (not shown), ROM (not shown), and RAM (not shown). The image displaying apparatus 7 receives medical images from the medical information storage 8 and displays them with its application software called “image viewer”.

The medical information storage 8 is an apparatus to keep medical information received from various other apparatuses. The medical information storage 8 is a so-called “computer” and is configured to include a CPU (not shown), ROM (not shown), RAM (not shown), and a large-capacity storage device (not shown).

### [Configuration of the Electronic Patient Chart Apparatus]

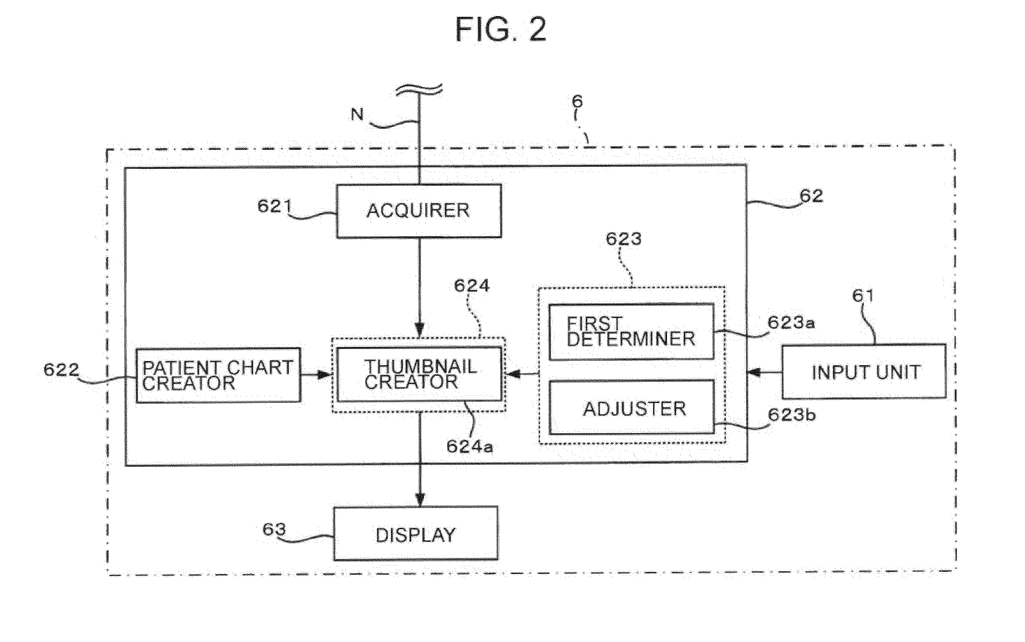

FIG. 2 is a block diagram showing the details of the electronic patient chart apparatus 6 as this embodiment. The electronic patient chart apparatus 6 is configured to include an input unit 61, a CPU 62, and a display 63.

### (Input Unit)

The input unit 61 is provided for inputting various instructions to the electronic patient chart apparatus 6. The input unit 61 comprises, for example, a keyboard, a mouse, a trackball, and a joystick. In addition, GUI (Graphical User Interface) items displayed on the display 63 can be used as the input unit 61.

### (CPU)

In this embodiment, the CPU 62 functions as an acquirer 621, a patient chart creator 622, a processor 623, and a display controller 624 under the control of its dedicated application software.

The acquirer 621 obtains, from the medical information storage 8, medical information such as electronic patient charts, medical images, and examination information in accordance with instructions input with the input unit 61. As a specific example, when a patient ID is input with the input unit 61, the acquirer 621 reads out the electronic patient chart that corresponds to the patient ID from the medical information storage 8. The read-out electronic patient chart is displayed in a window on the display screen 63a by the display controller 624 in accordance with predetermined displaying conditions (described later). In addition, if there are medical images and examination information that are related to the patient ID, the acquirer 621 obtains the information from the medical information storage 8 and makes a list that includes only the item names of the medical information (e.g., “endoscope image”, “blood test information”, and “diagnostic report”). The list is displayed, for example, on the patient chart by the display controller 624. If a certain item is selected on the list with the input unit 61, then the display controller 624 displays, on the display screen 63a, a window that includes medical information that corresponds to the list (details of a process opening a plurality of windows will be described later). Displaying conditions for the window are determined in advance by each of the apparatuses. The term “displaying conditions” are conditions applied for displaying a window on the display screen 63a. Examples of the “displaying conditions” are size, shape, and position for displaying windows.

The patient chart creator 622 writes a diagnostic description and the like in the patient chart being displayed on the display screen 63a in accordance with instructions input with the input unit 61. As a specific example, if the input unit 61 is a keyboard, then the patient chart creator 622 writes a diagnostic description by recording characters that correspond to the letter keys pushed down by the physician as electronic data, in an input box of the patient chart.

The processor 623 executes various processes on the window that presents medical information acquired by the acquirer 621. The processor 623 in this embodiment is configured to include a first determiner 623a and an adjuster 623b.

In the case where at least a first window is displayed on the display screen 63a, if an additional second window is to be displayed on the display screen 63a, then the first determiner 623a determines whether or not the display screen 63a has an area sufficient for displaying a second window, considering the display area of the first window and the displaying conditions to be applied for the second window. In this embodiment, the term “first window” means a window displayed first on the display screen 63a. The term “second window” means a window displayed newly on the display screen 63a, where the first window has already been displayed.

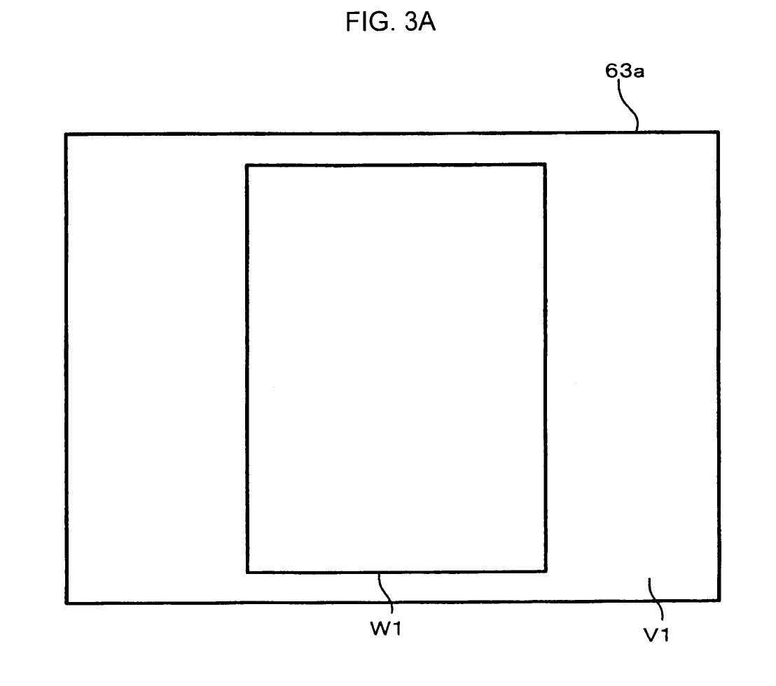

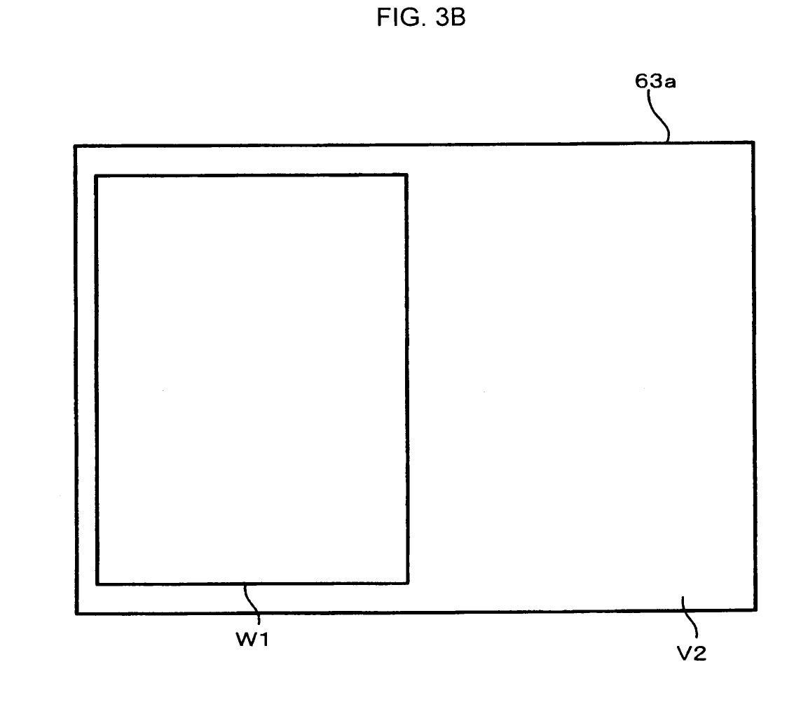

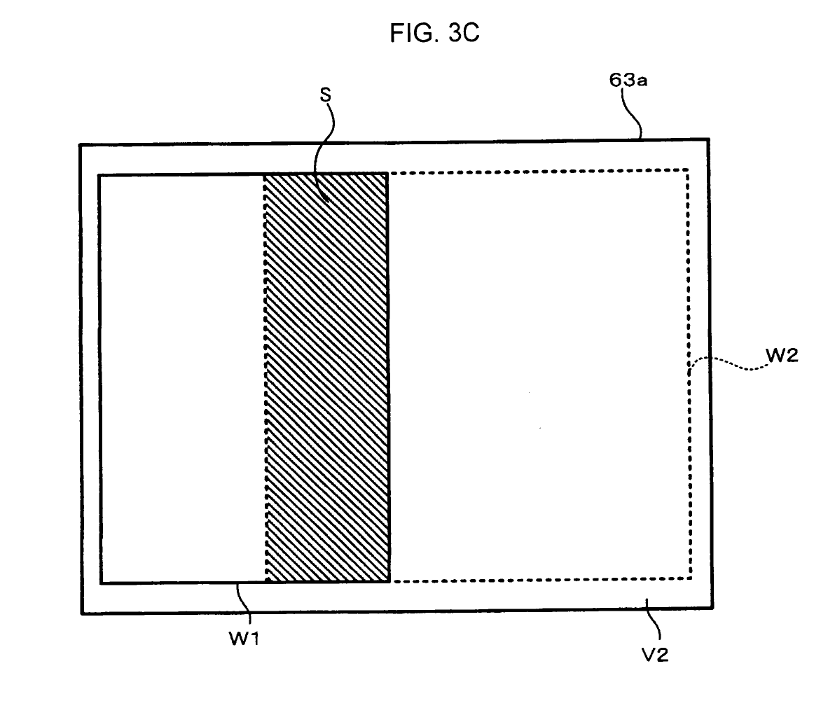

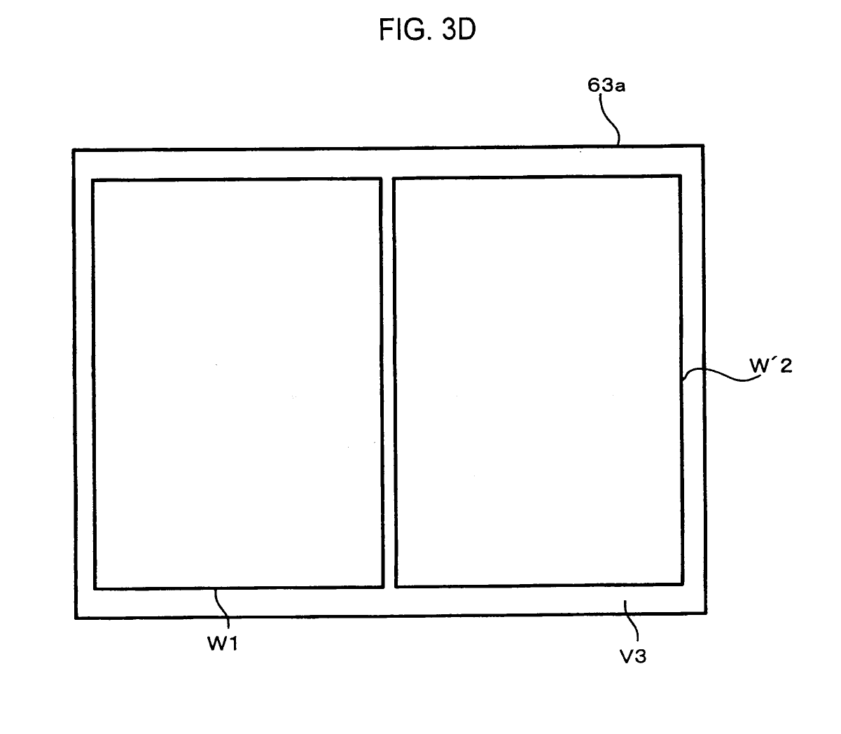

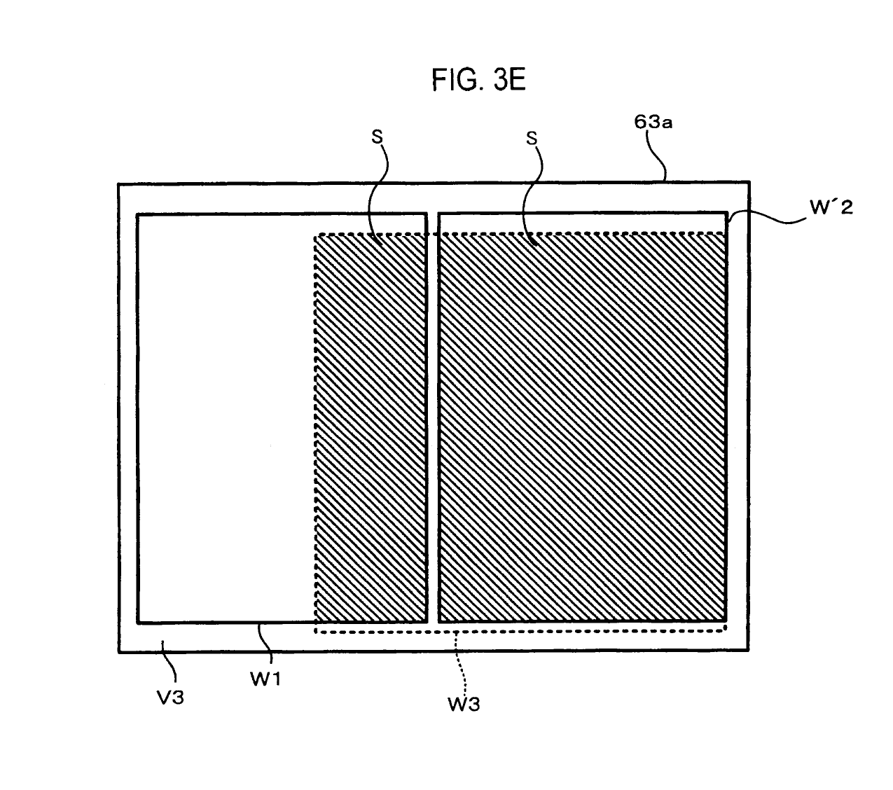

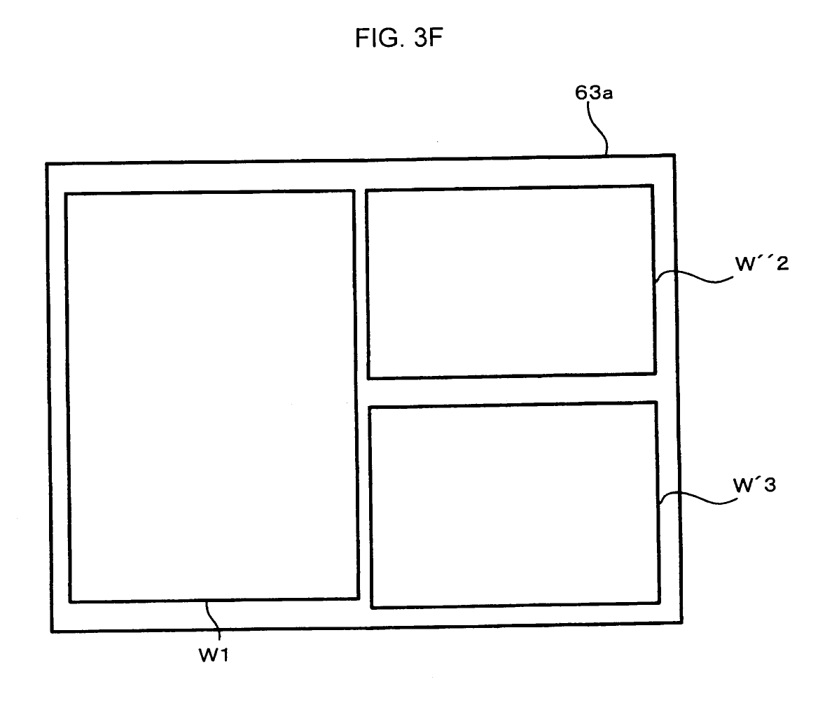

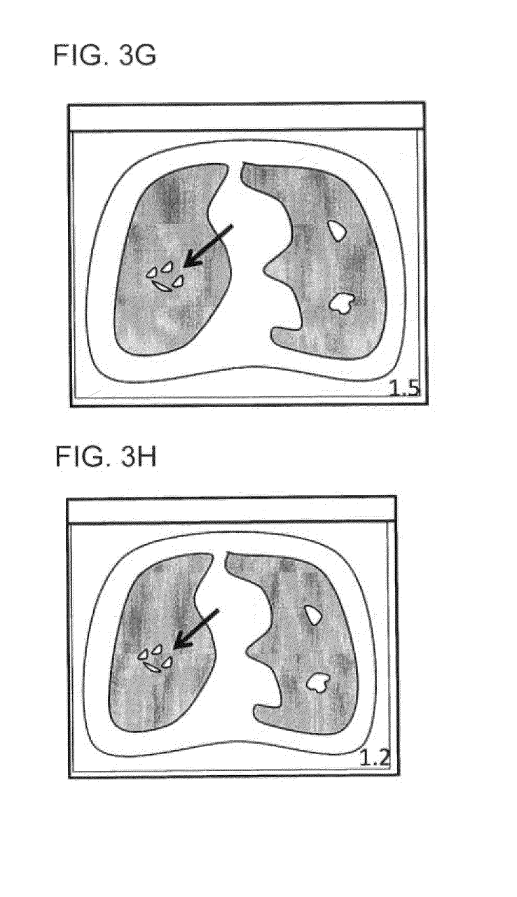

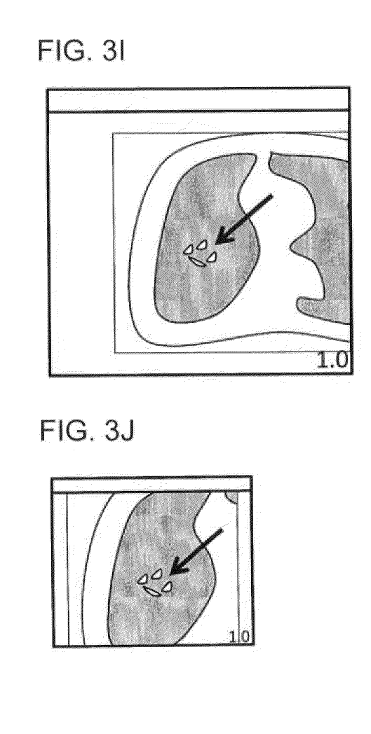

As a specific example, the following is a description that in the case where a window W1 for patient chart is displayed as a first window on the display screen 63a (refer to FIG. 3A), an instruction is given to display another window W2 for blood test information as a second window.

In the state where a window W1 has been displayed on the display screen 63a, if an instruction is given with the input unit 61 to select the blood test information, then the first determiner 623a recognizes the display area of the window W1 on the display screen 63a by executing image-processing such as edge-detection and then designates the remaining area of the display screen 63a as a free area V1 (the area not occupied by the window W1) (refer to FIG. 3A). The first determiner 623a compares the displaying conditions predetermined for the window W2 for blood test information with the free area V1 to determine whether or not the window W2 can be displayed in the free area V1.

If the window W2 cannot be displayed in the free area V1, then the first determiner 623a calculates the size of a free area V2 that can result if the window W1 is moved on the display screen 63a, and then the first determiner determines whether or not the window W2 can be displayed in the free area V2 (refer to FIG. 3B). The movement of the window W1 is automatically executed by the display controller 624 on the basis of the result of the determination done by the first determiner 623a (e.g., the determination results that it is impossible to display the window W2 in the free area V1). Instead, the movement of the window W1 can be executed arbitrarily by an instruction input with the input unit 61.

The first determiner 623a sends these determination results to the adjuster 623b. By the way, it is possible to omit the processing about the above-mentioned determination that executed by the first determiner 623a when the window W2 cannot be displayed in the free area V1.

After the first determiner 623a has determined that there is no area that allows displaying of the window W2 (in the free areas V1, V2), the adjuster 623b adjusts the displaying conditions of the window W1 and/or window W2 so that the window W1 and window W2 can be both displayed on the display screen 63a.

The following description is a specific example in which the adjuster 623b adjusts the display size of a window as a displaying condition. In this embodiment, if the window W1 is already displayed on the display screen 63a (refer to FIG. 3B), then the entirety of a window W2 for blood test information cannot be displayed in its predetermined display size. Displaying the window W2 in its predetermined display size would create an overlapped area S, where the window W1 and window W2 overlap each other (refer to FIG. 3C). If the windows overlapped in this way, then it would make the medical information provided in the overlapped area S difficult to be noticed.

In such a case, the adjuster 623b determines whether or not both window W1 and window W2 can be displayed on the display screen 63a if the windows are in their minimum display size, based on the information of the minimum display sizes of the window W1 and window W2. The term “minimum display size” means a predetermined value and is a display size for the entirety of the minimized window that still allows recognition of the medical information provided in the window displayed on the display screen 63a.

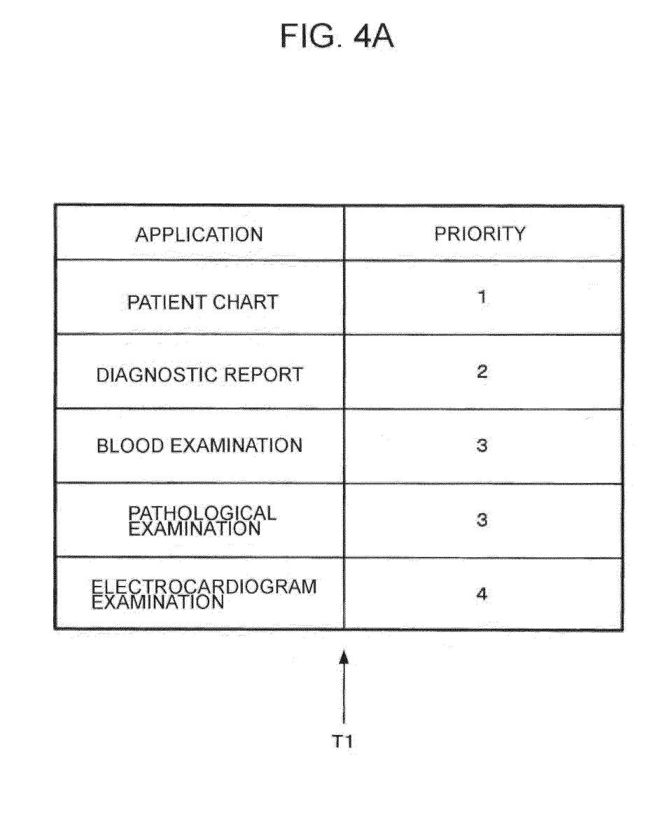

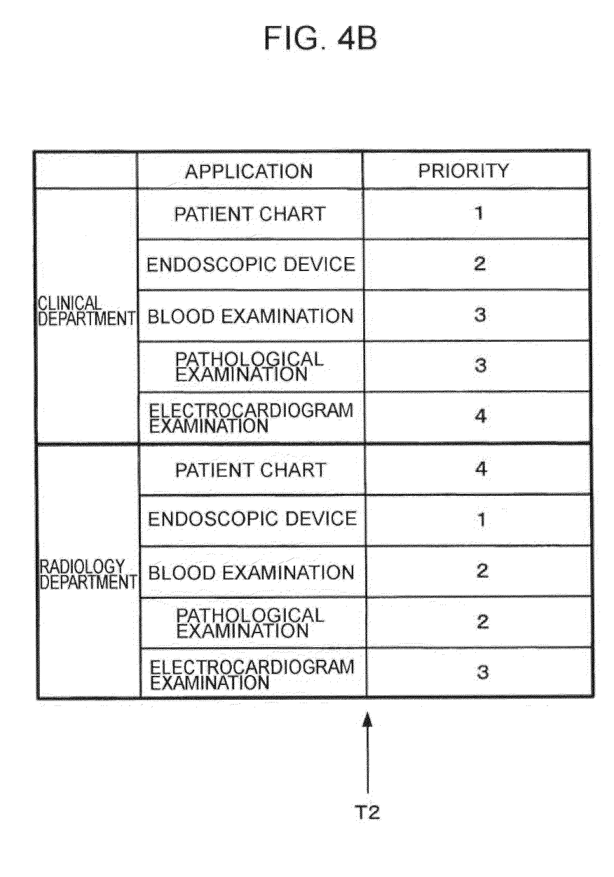

As a specific example, the adjuster 623b determines whether or not the sum of the minimum display sizes of the window W1 and window W2 is equal to or smaller than the size of the display screen 63a. If the determination results in that both window W1 and window W2 can be displayed (the determination results in that the displaying conditions can be adjusted), then the adjuster 623b reads out table information T1 about a predetermined order of priority (refer to FIG. 4A), which information is stored in a storage (not shown). Based on the priority order, the adjuster 623b determines which window to change in its display size and then adjusts the display size of an appropriate window. The “table information” is information that relates applications to the priority order. In the table information T1, “1” indicates the highest priority. The larger the number grows, the lower the priority becomes.

In this embodiment, as shown in the table information T1, the priority of the patient chart is higher than that of the blood test information. The adjuster 623b, therefore, executes adjustment to reduce the window W2 for blood test information. The display controller 624 displays the window W′2 for blood test information on the display screen 63a, based on the result of the adjustment done by the adjuster 623b (refer to FIG. 3D).

In the adjustment, the adjuster 623b may reduce the size of the window to the minimum display size regardless of the available free area or to a size that matches the free area, which has been specified by the first determiner 623a, (e.g., to the maximum size that can be displayed in the free area).

FIG. 3D shows an example, in which the window W2 is reduced and displayed to fit the free area V2.

The window whose display size to be adjusted is not restricted to one of the windows. For example, the adjuster 623b may reduce both window W1 and window W2. Instead, the adjuster 623b can execute adjustment to extend window W1, which has a higher priority, to a size that will be larger than the current display size and to reduce window W2, which has a lower priority. Besides, every time when windows are to be displayed, the window targeted for adjustment can be selected by an instruction input with the input unit 61, disregarding the priority order defined in the table information.

The minimum display size is not restricted to the display size of the entire window. For example, as for windows for providing endoscopy information, i.e., windows displaying medical images, if the window display size should be reduced, it is desirable that medical images be given priority and be displayed larger than other accompanying information (of examination conditions, etc). In such a case, the minimum display size may be determined based on the size of medical images. The size of medical images depends on the pixel numbers in length and width of the images. The size of medical images includes not only the whole size of medical images but also the size of partial areas of medical images (e.g., the size of an attention area in medical images, for which area an annotation is added).

In addition, when the “minimum display size” is in a size that allows display in pixel actual size, there is a case where even the “minimum display size” cannot display necessary information.

FIGS. 3G-J are drawings that show an example of the display screen. As shown in FIG. 3G and FIG. 3H, if there is no lack of pixel information, the adjuster 623b executes image reduction to pixel actual size (magnification of lx).

FIG. 3G shows an image at a magnification of 1.5× (the magnification is indicated with the number “1.5” in the lower right of the drawing), and FIG. 3H shows the same image at a magnification of 1.2× (the magnification is indicated with the number “1.2” in the lower right of the drawing). Furthermore, FIGS. 3G-3J show an annotation of “->”, which is displayed on each image.

If image reduction is executed to a magnification of 1×, then there may be a case where necessary pixel information cannot be displayed. If further image reduction is required, then the adjuster 623b focuses the displaying area to the vicinity of the annotation “->”. FIG. 3I shows the image at a magnification of 1× with the displaying area being focused on the vicinity of the annotation “->” (the magnification is indicated with the number “1.0” in the lower right of the drawing). Furthermore, FIG. 3J shows a focused displaying area (the magnification is indicated with the number “1.0” in the lower right of the drawing).

Furthermore, the adjustment of the display size is not limited to the adjustment based on the minimum display size. For example, if the window W1 for patient chart and the window W′2 for blood test information have once been displayed on the display screen 63a, then each display size is memorized in a storage (not shown). Later when a window for patient chart and a window for blood test information are to be displayed on a different occasion, the adjuster 623b can adjust the display size of each window on the basis of the past display sizes. As another example, if only the window W1 for patient chart has once been displayed on the display screen 63a, the display size of the window W1 is memorized in a storage (not shown). Later when a window for patient chart and a window for blood test information are to be displayed on a different occasion, the adjuster 623b adjusts the display size of the window for patient chart on the basis of the memorized display size. In addition, the adjuster 623b can also determine the display size of the window for blood test information, which is to be newly displayed, on the basis of the memorized display size of window W1 and the size of the display screen 63a.

The adjuster 623b can also adjust the display position and display shape of the window W1 and/or window W2 on the display screen 63a in addition to the display size. Based on the result of the adjustment done by the adjuster 623b, the display controller 624 executes moving of the window and so on.

Priority may be determined for each of the specialties of the hospital. For example, different priorities may be set for clinical department and for radiology department. Specifically, in the clinical department, since the input of data to patient charts is done mainly, the window for patient chart takes top priority. On the other hand, in the radiology department, since the interpretation of CT images is done mainly, the window for CT image takes priority over the window for patient chart (refer to FIG. 4B, which shows another table information T2). In the table information T2, “1” indicates the highest priority, and the larger the number grows, the lower the priority becomes.

The processes executed by the first determiner 623a and the adjuster 623b are similarly executed also in the case where a plurality of windows are displayed as first windows. The following description is a specific example in which an instruction is given to display a window W3 for pathological examination information as a second window while the windows W1 and W′2 are displayed as first windows on the display screen 63a (FIG. 3D).

In the state where the windows W1 and W′2 are displayed on the display screen 63a, if a selection is made for pathological examination information by an instruction input with the input unit 61, then the first determiner 623a recognizes the display area of the window W1 and window W′2 on the display screen 63a by executing image-processing such as edge-detection and specifies the remaining area of the display screen 63a as free area V3 (the area where the window W1 and window W′2 are not displayed). The first determiner 623a compares the displaying conditions predetermined for the window W3 for pathological examination information to the free area V3 and determines whether or not the window W3 can be displayed in the free area V3. The first determiner 623a sends the determination result to the adjuster 623b.

In this embodiment, while the window W1 and window W′2 are displayed on the display screen 63a (refer to FIG. 3D), the window W3 for pathological examination information cannot be displayed in its predetermined display size (refer to FIG. 3E). If the window W3 were displayed in its predetermined display size, it would create an overlapped area S, where the window W1 and window W′2 and window W3 overlap one another (refer to FIG. 3E). If the windows overlapped in this way, then it would make the medical information provided in the overlapped area S difficult to be noticed.

In such a case, the adjuster 623b determines whether or not all the three windows can be displayed on the display screen 63a if each window is made into its minimum display size, by referring to the information of the minimum display sizes of the three windows (window W1, window W′2 and window W3). As a specific example, the adjuster 623b determines whether or not the sum of the minimum display sizes of the three windows is equal to or smaller than the size of the display screen 63a. If the result of the determination is that all the windows can be displayed, then the adjuster 623b reads out the table information T1 (refer to FIG. 4A), which is a predetermined order of priority stored in a storage (not shown). The adjuster 623b then specifies the windows whose display sizes be changed, based on the priority order, and the adjuster adjusts the display sizes. In this embodiment, as shown in the table information T1, patient chart is given the highest priority (priority “1”) while blood test information and pathology information are given an equal priority (priority “3”). The adjuster 623b, therefore, adjusts the sizes of the window W′2 for blood test information and the window W3 for pathological examination information such that both the windows will have the same reduced size. The display controller 624 displays the window W″2 for blood test information and the window W′3 for pathological examination information on the display screen 63a, based on the result of the adjustment done by the adjuster 623b (refer to FIG. 3F).

The display controller 624 executes displaying control for the display 63. For example, the display controller 624 executes control to display medical images, diagnostic reports, and so on, which have been acquired with the acquirer 621, in windows of predetermined display sizes, on the display 63.

In this embodiment, the display controller 624 is configured to include a thumbnail creator 624a. The thumbnail creator 624a thumbnails some windows of the windows displayed on the display screen 63a, and the thumbnailed windows are displayed on the display screen 63a by the display controller 624.

### (Display)

The display 63 is a display device, which is used for displaying each of the windows for patient chart, diagnostic report, medical image, and so on.

In the above-mentioned configuration, the first determiner 623a, the adjuster 623b, the display controller 624, and the display 63 constitute an example of a “medical information displaying apparatus” as the present embodiment.

### [Actions]

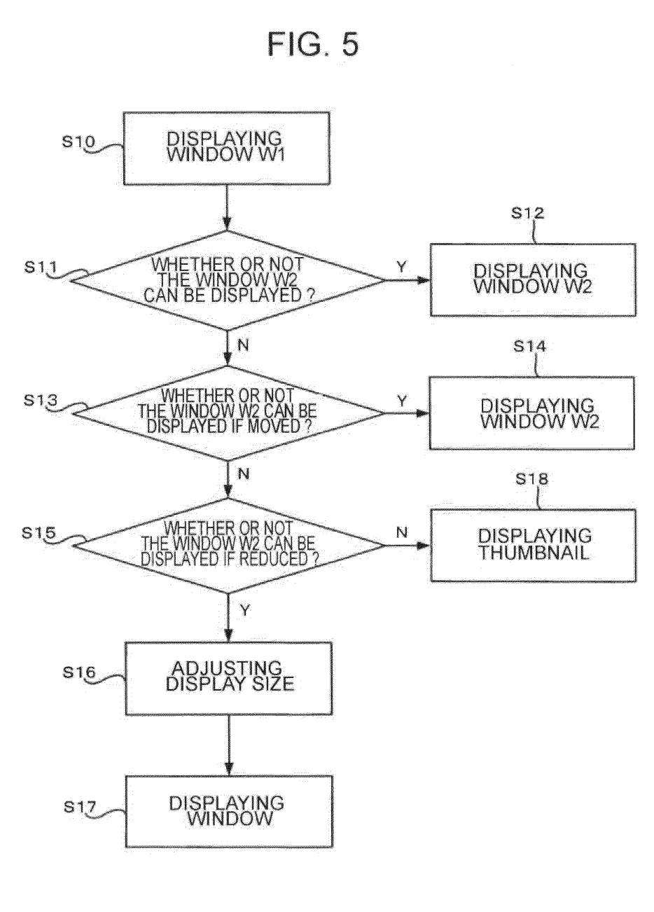

Now, actions taken by the electronic patient chart apparatus 6 as this embodiment are described with reference to FIG. 5.

In the electronic patient chart apparatus 6, at first, when a patient ID is input with the input unit 61, the acquirer 621 obtains a patient chart that relates to the patient ID from the medical information storage 8. The display controller 624 displays the obtained patient chart in a window (window W1) on the display screen 63a (S10).

In the state at S10, if an instruction is input with the input unit 61 to display a window W2 for blood test information, then the first determiner 623a recognizes the display area of the window W1 by executing edge-detection on the display screen 63a and specifies the remaining area of the display screen 63a as free area V1. The first determiner 623a compares the displaying conditions predetermined for the window W2 for blood test information to the free area V1 and determines whether or not the window W2 can be displayed in the free area V1 (S11).

If the determination results in that the window W2 can be displayed in the free area V1, which has been specified at S11 (in the case of Y at S11). The display controller 624 displays the window W2 in the free area V1 (S12).

On the other hand, if the determination results in that the window cannot be displayed in the free area V1 (in the case of N at S11), the first determiner 623a determines another free area V2 that can result if the window W1 currently displayed is moved on the display screen 63a, and the first determiner then determines whether or not the window W2 can be displayed in this free area V2 (S13).

If the determination results in that the window W2 can be displayed in the free area V2 specified at S13 (in the case of Y at S13), the display controller 624 moves the window W1 and displays the window W2 in the free area V2 that has resulted from the movement (S14).

On the other hand, if the determination results in that the window W2 cannot be displayed in the free area V2 even with movement of the window W1, (in the case of N at S13), the adjuster 623b determines whether or not the window W1 and window W2 can be displayed on the display screen 63a if each window is reduced. The determination is based on the information of the minimum display sizes of the window W1 and window W2 (S15).

If the determination results in that the window W1 and window W2 can be displayed with their window display sizes being reduced (in the case of Y at S15), the adjuster 623b specifies the window whose display size be changed based on the priority order defined in the table information and adjusts the display size accordingly (S16). The display controller 624 displays the window W1 and window W2 in their display sizes adjusted at S16 (S17).

On the other hand, if the determination results in that the window W1 and window W2 cannot be displayed even with the windows being reduced to their minimum display sizes (in the case of N at S15), the thumbnail creator 624a thumbnails either one of the windows and displays it in connection with the other window on the display screen 63a (S18). Instead, it is also possible that the display controller 624 display a warning message that indicates the impossibility of displaying the window, on the display screen 63a.

Incidentally, actions at S13 (and S14) can also be omitted. In other words, if the determination at S12 results in that the window W2 cannot be displayed, then the determination at S15 can be immediately executed.

Here, an example is presented to describe a case where a physician at a clinical department orders an examination to be performed on a next occasion by using a patient chart. The physician, at first, obtains from the medical information storage 8 a patient chart by using a patient ID, causing the display screen 63a to display the chart. He or she then selects blood test information, endoscopy information, and so on, and causes the information in respective windows to be displayed. By referring to the medical information in the windows, the physician inputs into the patient chart an order of an examination to be performed on a next occasion. In other words, every time when a new window is displayed, the electronic patient chart apparatus 6 executes the processes S11-S18.

The above-mentioned configuration (the first determiner 623a, the adjuster 623b, the display controller 624, and the display 63) can also be provided in the report-generating apparatus 4, the image displaying apparatus 7, or the like. For example, an instruction input by a physician at a physiology laboratory causes the display of the report-generating apparatus 4 to display a window for endoscopy information and a window for blood test information. At this instant, the displaying conditions of the windows are adjusted by executing the above-mentioned processing. As a result, the physician can create a diagnostic report by inputting findings while referring to the contents in the windows. In other words, a similar effect can be achieved by providing the above-mentioned configuration in the report-generating apparatus 4. In such a case, the configuration provided in the report-generating apparatus 4 or image displaying apparatus 7 is an example of the “medical information displaying apparatus”.

### [Operation and Effects]

The following description concerns the operation and effects of the medical information displaying apparatus as the first embodiment.

The medical information displaying apparatus comprises a display 63, a display controller 624, a first determiner 623a, and an adjuster 623b. The display controller 624 causes the display 63 to display a plurality of windows, each of which has a predetermined display size, on the display screen 63a of the display 63. In the case where at least a first window is displayed on the display screen 63a, if a second window is to be displayed additionally on the display screen 63a, the first determiner 623a determines whether or not there is an area sufficient for displaying the second window on the display screen 63a. The determination is based on the display area of the first window and the displaying conditions for the second window. If the determination results in that no area sufficient for displaying the second window is available, then the adjuster 623b determines whether or not it is possible to make adjustment to the displaying conditions of the first window and/or the second window so that the first window and the second window will be displayed on the display screen. If the determination results in that the displaying conditions can be adjusted, then the adjuster 623b adjusts the displaying conditions.

In this embodiment, the adjuster 623b adjusts the display sizes of the first window and/or the second window as displaying conditions. More specifically, the adjuster 623b adjusts the display sizes of the first window and the second window in accordance with the minimum display size of each of the first and second windows.

In this way, the first determiner 623a determines, based on the display area of the first window, whether or not there is an area sufficient for displaying a second window on the display screen 63a in compliance with the displaying conditions of the second window. The adjuster 623b, then, automatically adjusts the displaying conditions (e.g., display size) of the first window and/or the second window so that the first window and the second window will be displayed on the display screen 63a, and therefore, there is no need of hand-operated adjustment of the window display size, and so on, every time when a new window is displayed. As a result, efficiency can be improved in such work as interpreting medical images or performing diagnostic examination, which is performed with a plurality of windows being displayed on the display screen.

In addition, in this embodiment, the display controller 624 (thumbnail creator 624a) thumbnails the first window and/or the second window if the adjuster 623b has determined that it is impossible to adjust the displaying conditions of the windows, and the display controller displays the thumbnails on the display screen 63a.

With the windows thumbnailed in this way, the physician arbitrarily selects any of the thumbnails so that the corresponding window will be displayed in accordance with his or her need on the display screen. In other words, even when a whole of a certain window cannot be displayed, thumbnailing the window makes closure of other windows unnecessary. As a result, efficiency can be improved in such work as interpreting medical images or performing diagnostic examination.

In addition, in this embodiment, the minimum display size may be determined on the basis of the size of a medical image that is displayed in each of the first window and the second window.

If the size of a medical image is applied as the minimum display size of the window in such a way, then even with the reduced window, the medical image can be ensured of recognition for interpretation or diagnostic examination. As a result, efficiency can be improved in such work as interpreting medical images or performing diagnostic examination.

In addition, in this embodiment, the adjuster 623b adjusts the display sizes of the first window and the second window based on the display sizes applied in the past to the first window and/or second window.

Even if the window display size is adjusted based on past display size in such a way, hand-operated adjustment of the window display size or the like is made unnecessary every time when a new window is displayed. As a result, efficiency can be improved in such work as interpreting medical images or performing diagnostic examination, which is performed with a plurality of windows being displayed on the display screen.

Furthermore, in this embodiment, the adjuster 623b selects a window whose display size is to be adjusted based on a predetermined priority order and adjust the display sizes accordingly.

Selecting a window whose display size is to be adjusted, in such a way, i.e., based on a priority order, allows windows necessary for image interpretation or diagnostic examination to take precedence over other windows. As a result, even with a plurality of windows being displayed on the display screen, image interpretation, diagnostic examination, or the like can be performed efficiently.

Moreover, in this embodiment, the adjuster 623b adjusts the display positions of the first window and/or the second window on the display screen 63a in addition to the adjustment of the display sizes as displaying conditions.

In this way, i.e., by adjusting the window display position in addition to the display size, a window can be effectively disposed in a free area. In addition, the adjusting of the window display position can allow the placement of a window in a desired position. In other words, the placement of windows can be adjusted to the preference of the physician or the like. As a result, efficiency can be improved in such work as interpreting medical images or performing diagnostic examination, which is performed with a plurality of windows being displayed on the display screen.

### Second Embodiment

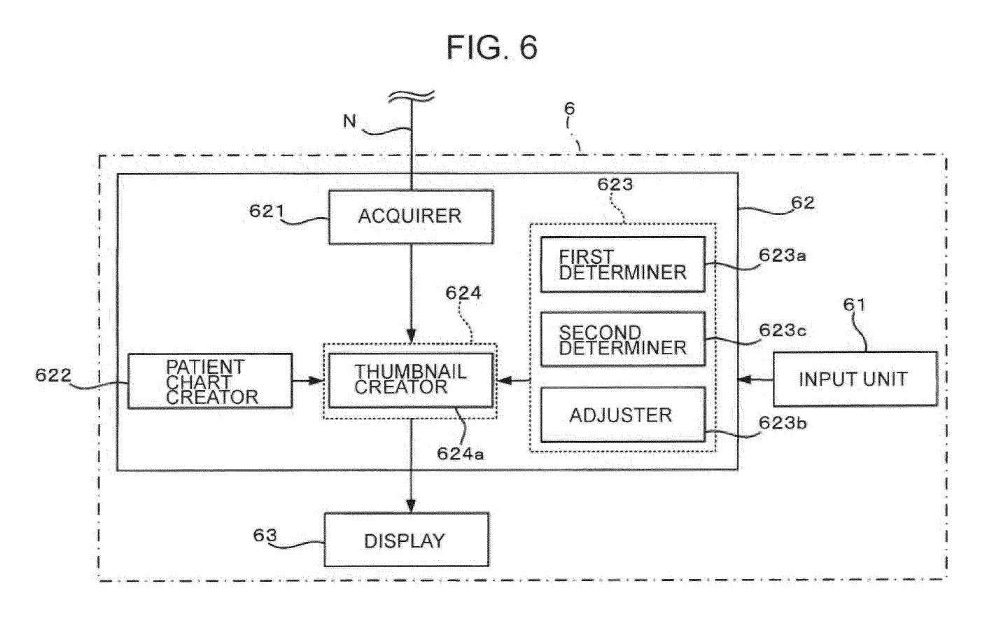

Now, the configuration of a medical information displaying apparatus as a second embodiment (a part of the electronic patient chart apparatus 6) is described with reference to FIG. 6 through FIG. 9. Detailed descriptions may not be given of the parts of the configuration that are the same as the first embodiment.

### [Configuration of the Electronic Patient Chart Apparatus]

FIG. 6 is a block diagram showing the details of the electronic patient chart apparatus 6 as this embodiment. The electronic patient chart apparatus 6 is configured to include an input unit 61, a CPU 62, and a display 63 in the same way as the first embodiment.

### (Input Unit)

The input unit 61 is provided for inputting various instructions to the electronic patient chart apparatus 6.

### (CPU)

In this embodiment, the CPU 62 functions as an acquirer 621, a patient chart creator 622, a processor 623, and a display controller 624 under the control of its dedicated application software.

The acquirer 621 acquires medical information such as a patient chart, a medical image, and examination information from the medical information storage 8 in response to an instruction input with the input unit 61 or the like. The patient chart creator 622 writes a diagnostic description or the like in the patient chart displayed on the display screen 63a, in response to an instruction input with the input unit 61 or the like.

The processor 623 executes various processes on the window showing the medical information acquired by the acquirer 621. The processor 623 in this embodiment is configured to include a first determiner 623a, an adjuster 623b, and a second determiner 623c.

In the case where at least a first window is displayed on the display screen 63a, if a second window is to be additionally displayed on the display screen 63a, then the first determiner 623a determines, based on the display area of the first window, whether or not there is an area sufficient for displaying the second window on the display screen 63a in compliance with the displaying conditions of the second window.

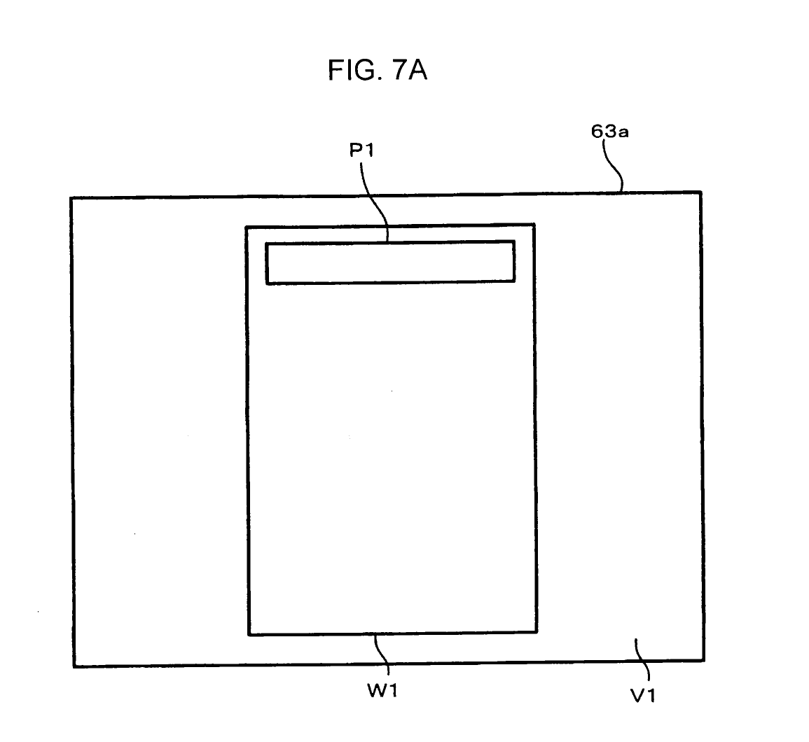

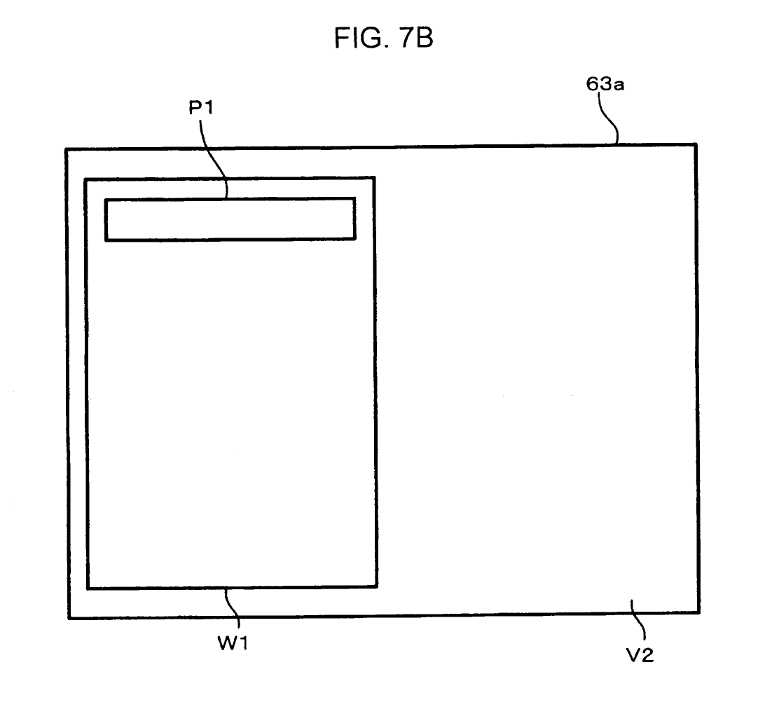

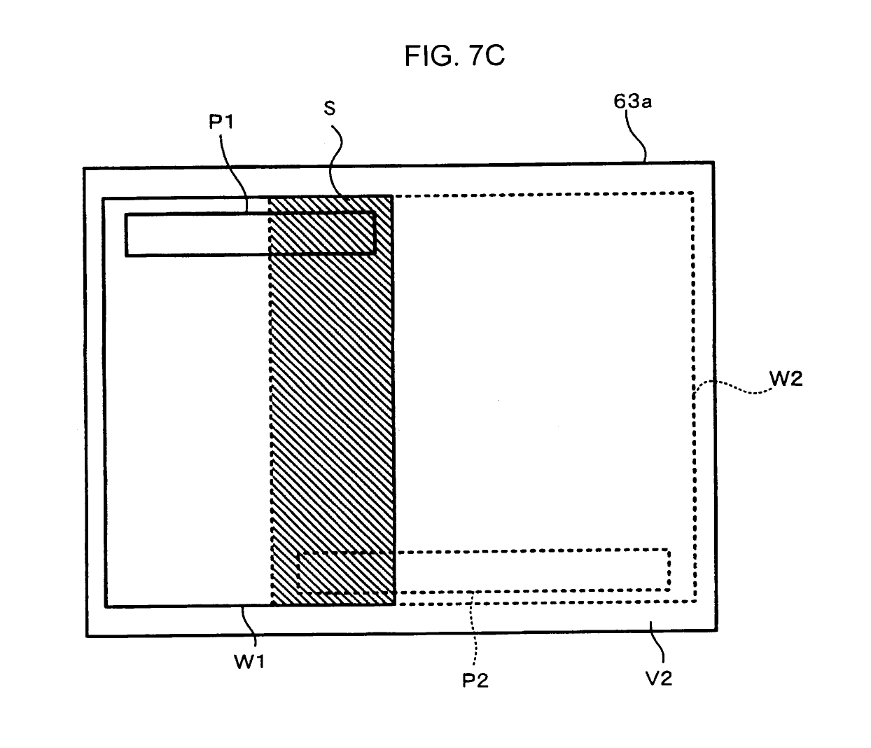

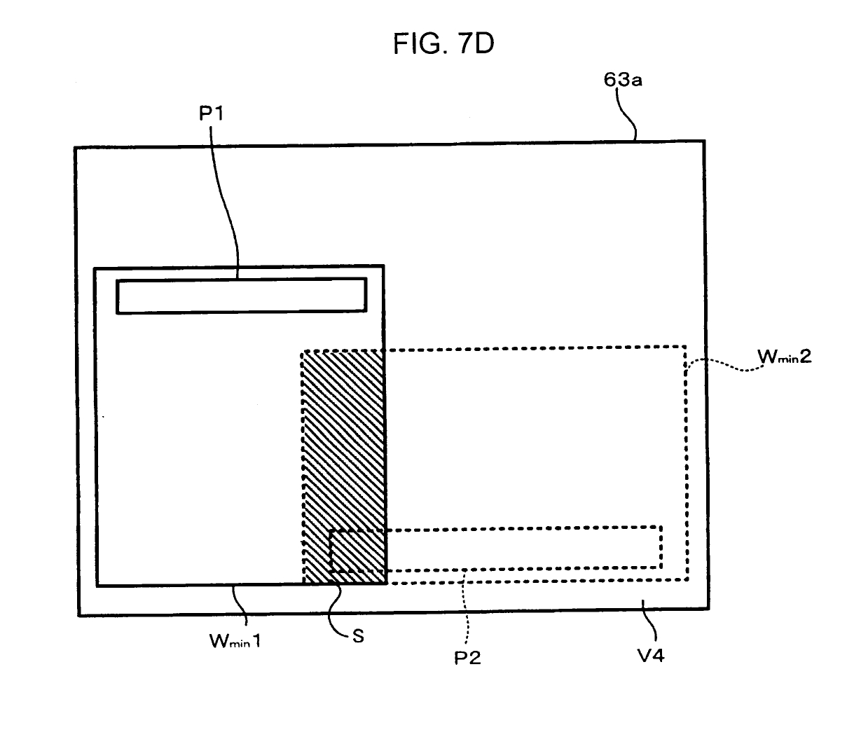

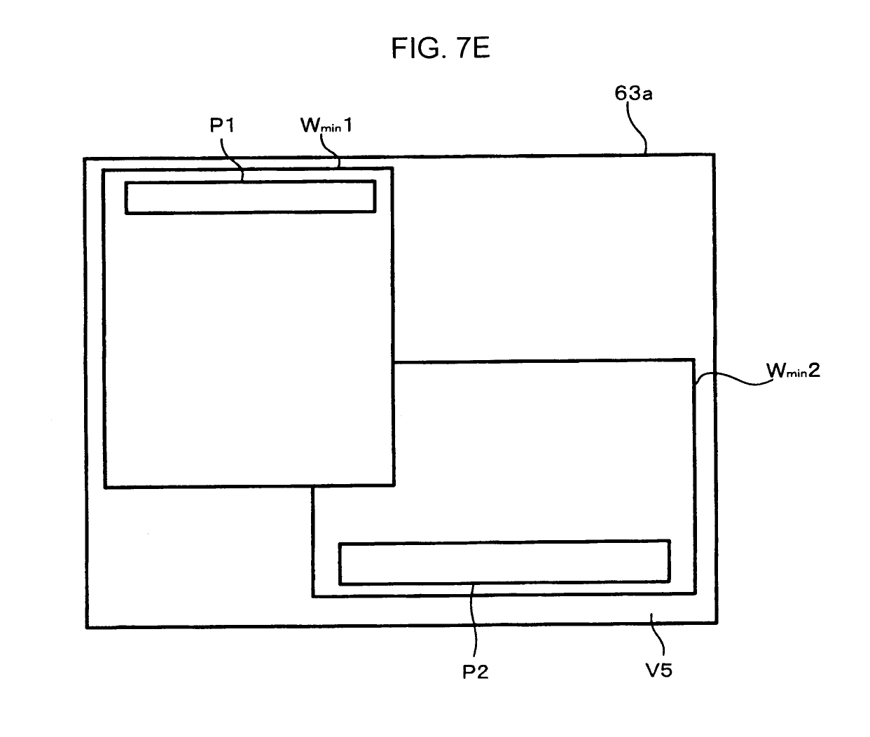

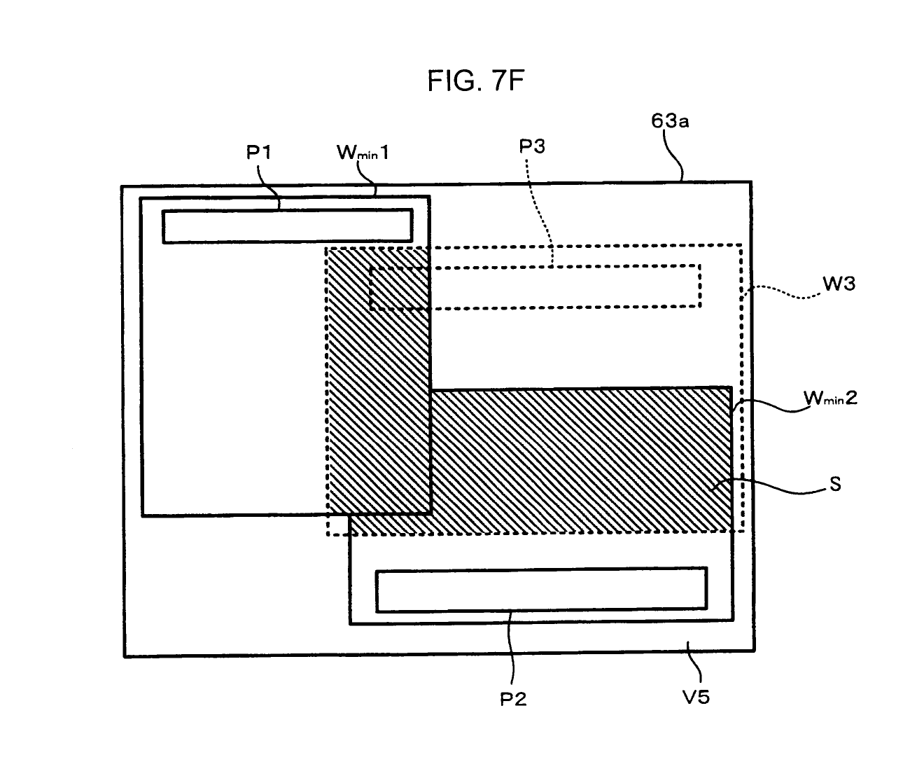

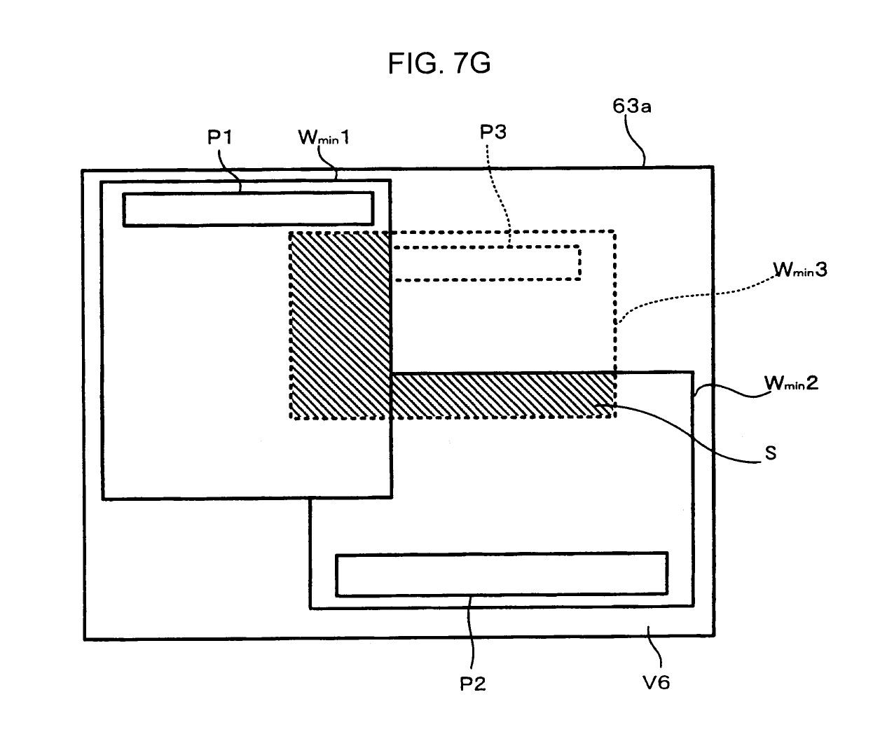

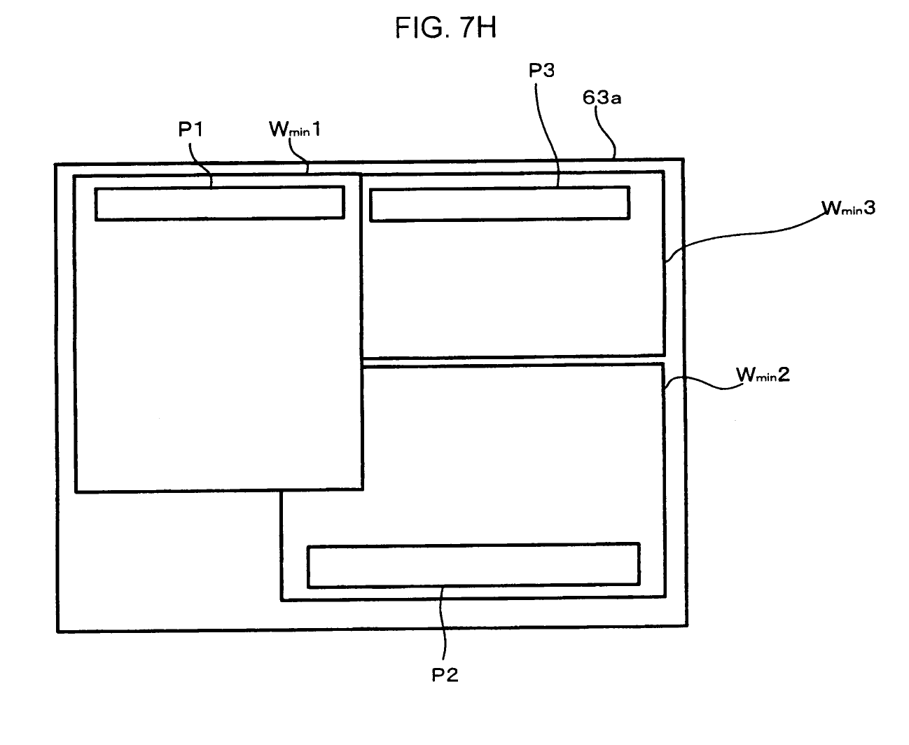

The following is a specific example in which while a window W1 for patient chart is displayed as a first window on the display screen 63a (refer to FIG. 7A), an instruction is given to display a window W2 for blood test information as a second window.

In this embodiment, window W1 is provided with a patient ID display field P1 as a specified area (refer, for example, to FIG. 7A), and window W2 is also provided with a patient ID display field P2 as a specified area (refer, for example, to FIG. 7C). The term “specified area” means an area where information that should be especially noticed is displayed in a window displayed on the display screen 63a. For example, if a plurality of windows are displayed on the display screen 63a, then the patient ID display fields need to be paid attention to see if both the windows are for the same patient. It is, therefore, desirable that the patient ID display field of each of the windows be displayed in such a way that a physician or the like can always confirm the identification with his or her eyes. Incidentally, the specified area is not restricted to such patient ID display field. For example, with the window for CT image and the window for endoscopic image, it is important to identify the images, which have been achieved with the medical imaging apparatus 2. In such a case, the specified area can be set as the image area of the window. The specified area may be either set in advance for the type of windows (the type of applications) (refer to table information T3, which is described later) or specified each time with the input unit 61 or the like.

In the case where a window W1 is displayed on the display screen 63a, if blood test information is selected by an instruction input with the input unit 61 or the like, then the first determiner 623a recognizes the display area of the window W1 on the display screen 63a by executing image-processing such as edge-detection, and the first determiner specifies the remaining area of the display screen 63a as free area V1 (the area not occupied by the window W1) (refer to FIG. 7A). The first determiner 623a compares the displaying conditions predetermined for the window W2 for blood test information to the free area V1 and determines whether or not the window W2 can be displayed in the free area V1.

If the window W2 cannot be displayed in the free area V1, then the first determiner 623a determines the size of another free area V2 that can result if the window W1 is moved on the display screen 63a, and the first determiner also determines whether or not the window W2 can be displayed in this free area V2 (refer to FIG. 7B).

The first determiner 623a sends the determination results to the adjuster 623b. By the way, the above-mentioned determination the first determiner 623a executes when the window W2 cannot be displayed in the free area V1 can omit the processing.

If the first determiner 623a has determined that there is no area sufficient for displaying the window W2 (in the free areas V1, V2), then the adjuster 623b adjusts the displaying conditions of the window W1 and/or window W2 so that the window W1 and window W2 can be displayed on the display screen 63a.

The following description is a specific example in which the adjuster 623b adjusts the display size of a window as a displaying condition. In this embodiment, in the state where window W1 is displayed on the display screen 63a (refer to FIG. 7B), the entirety of window W2 for blood test information cannot be displayed in its predetermined display size. If window W2 were displayed in the predetermined display size, the window W1 and window W2 would create an overlapped area S (refer to FIG. 7C).

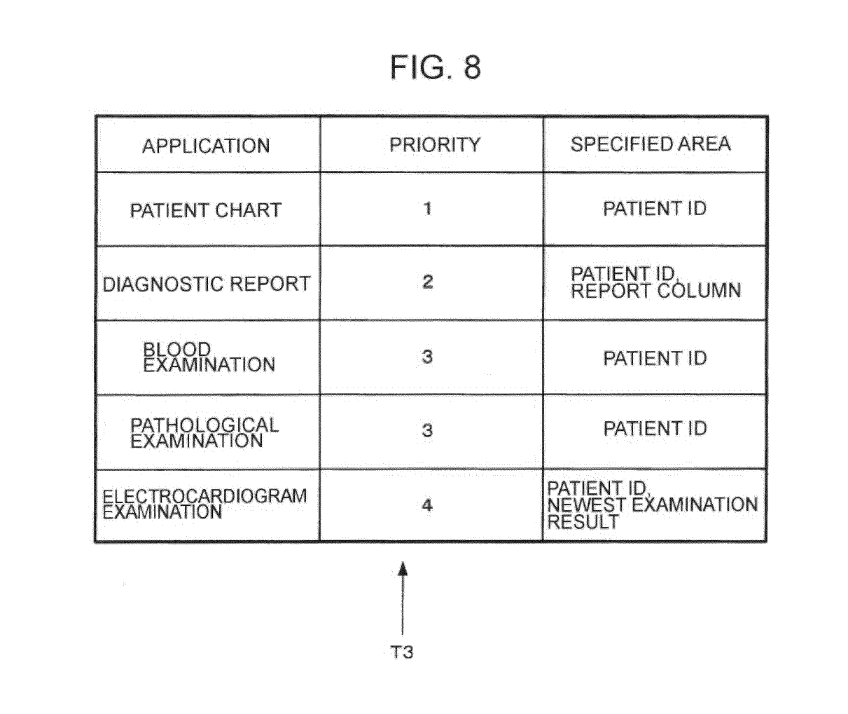

In such a case, the adjuster 623b determines whether or not the windows W1 and W2 can be displayed on the display screen 63a if each of the windows is reduced to its minimum display size, by referring to the information of the minimum display sizes of the windows W1 and W2. As a specific example, the adjuster 623b determines whether or not the sum of the minimum display sizes of the windows W1 and W2 is equal to or smaller than the size of the display screen 63a. If the determination results in that the windows W1 and W2 can be displayed (if the determination results in that the displaying conditions can be adjusted), then the adjuster 623b reads out table information T3 that describes a predetermined order of priority (refer to FIG. 8), which information is stored in a storage (not shown). The adjuster 623b then specifies the window whose display size be changed, based on the priority order; and the adjuster adjusts the display size. In the table information T3, “1” indicates the highest priority. The larger the number grows, the lower the priority becomes. Incidentally, in the table information T3, applications are related, respectively, to their specified areas.

On the other hand, if the determination results in that the windows W1 and W2 cannot be displayed (if the determination results in that the displaying conditions cannot be adjusted), then the adjuster 623b sends the determination result to the second determiner 623c. The case of the displaying conditions not being adjustable is, in other words, a case where an overlapped area S would result even if the windows W1 and W2 were reduced to their minimum display sizes (Wmin1, Wmin2) (or even if the windows were reduced and were moved) (refer to FIG. 7D).

The second determiner 623c determines whether or not overlaid display of the windows W1 and W2 is possible, based on the specified area of window W1 (patient ID display field P1) and the specified area of window W2 (patient ID display field P2).

As described above, there is a specified area that should be especially noticed of each of the windows. On the other hand, as for the areas other than the specified area, even if part of the window is covered by another window, it will not have much adverse effect. The second determiner 623c, therefore, specifies the specified areas (patient ID display field P1 and patient ID display field P2) of the windows W1 and W2. The specification of the areas involves, for example, table information T3. The second determiner 623c specifies patient ID display field P1 as the specified area for window W1, based on the table information T3. The second determiner 623c also specifies patient ID display field P2 as the specified area for window W2, based on the table information T3.

The second determiner 623c then determines whether or not the patient ID display fields P1 and P2 can be displayed on the display screen 63a if the windows W1 and W2 are reduced to their minimum display sizes (Wmin1, Wmin2). In other words, the second determiner 623c determines whether overlaid display of the windows W1 and W2 is possible. As a specific example, the second determiner 623c acquires the display areas for the case where the windows W1 and W2 are reduced to their minimum display sizes (Wmin1, Wmin2), by executing image-processing such as edge-detection, and the second determiner specifies the remaining area of the display screen 63a as free area V4 (the area where the windows Wmin1 and Wmin2 are not displayed) (refer to FIG. 7D). The second determiner 623c then determines whether or not the sum of the size of the patient ID display field P1 of window Wmin1 and the size of the patient ID display field P2 of window Wmin2 is equal to or smaller than the free area V4 of the display screen 63a. If the sum of the sizes of the patient ID display fields P1 and P2 is equal to or smaller than the free area V4 of the display screen 63a, then the patient ID display fields P1 and P2 can be displayed in the free area V4 by displaying the windows Wmin1 and Wmin2 partially overlaid one over the other (refer to FIG. 7E).

If the determination results in that the overlaid display is possible, then the second determiner 623c sends the determination result to the adjuster 623b.

The adjuster 623b adjusts the displaying conditions of the window W1 and/or window W2 so that the patient ID display field P1 of window W1 and the patient ID display field P2 of window W2 will be displayed at least on the display screen 63a. As a specific example, the adjuster 623b executes adjustment to reduce the windows W1 and W2 to their minimum display sizes (Wmin1, Wmin2) and to move the windows W1 and W2 so that the patient ID display fields P1 and P2 can be displayed in their entirety. In addition, in this embodiment, the adjuster 623b executes adjustment, based on the table information T3, to lay window Wmin1 over window Wmin2 so that the information of the patient chart that has the highest priority will come frontward in the overlapped area S. The display controller 624 displays the windows Wmin1 and Wmin2, which are partially overlaid one over the other on the display screen 63a, based on the result of the adjustment done by the adjuster 623b (refer to FIG. 7E). Incidentally, as long as the patient ID display fields P1 and P2 can be displayed respectively in their entirety, it is not necessary to reduce the windows W1 and W2 to their minimum display sizes.

The same processes performed by the first determiner 623a, the adjuster 623b, and the second determiner 623c are also executed for cases where a plurality of windows are displayed as the first window. The following description concerns a specific example in which an instruction is given to display a window W3 for pathological examination information as the second window in the state where the windows Wmin1 and Wmin2 are displayed as the first window on the display screen 63a (refer to FIG. 7E). By the way, in this embodiment, window W3 is also provided with a patient ID display field P3 as a specified area (refer, for example, to FIG. 7F).

In the case where the windows Wmin1 and Wmin2 are displayed on the display screen 63a, if pathological examination information is selected by an instruction input with the input unit 61 or the like, then the first determiner 623a recognizes the display areas of the windows Wmin1 and Wmin2 on the display screen 63a by executing image-processing such as edge-detection, and the first determiner specifies the remaining area of the display screen 63a as free area V5 (the area where the windows Wmin1 and Wmin2 are not displayed) (refer to FIG. 7E). The first determiner 623a then compares the displaying conditions predetermined for the window W3 for pathological examination information to the free area V5 and determines whether or not the window W3 can be displayed in the free area V5. The first determiner 623a sends the determination results to the adjuster 623b.

In this embodiment, in the state where the windows Wmin1 and Wmin2 are displayed on the display screen 63a (refer to FIG. 7E), the entirety of the window W3 for pathological examination information cannot be displayed in its predetermined display size. If the window W3 were displayed in its predetermined display size, then it would create an overlapped area S, where the windows Wmin1 and Wmin2 and the window W3 are overlaid one over another (refer to FIG. 7F).

In such a case, the adjuster 623b determines whether or not all the three windows can be displayed on the display screen 63a if each of the windows is reduced to its minimum display size, by referring to the information of the minimum display sizes of the three windows (windows W1, W2, and W3). As a specific example, the adjuster 623b determines whether or not the sum of the minimum display sizes of the three windows is equal to or smaller than the size of the display screen 63a. If the determination results in that all the windows can be displayed, then the adjuster 623b reads out the table information T3, which describes a predetermined order of priority and is stored in a storage (not shown). The adjuster 623b then specifies the window whose display size be changed based on the priority order and adjusts the display sizes accordingly. Incidentally, in this embodiment, the windows W1 and W2 are originally displayed in their minimum display sizes. There is, therefore, no case where the determination by the adjuster 623b results in that all the windows can be displayed.

On the other hand, if the determination results in that it is not possible to display all the windows, then the adjuster 623b sends the determination result to the second determiner 623c. In other words, the case where it is not possible to adjust the displaying conditions is a case where an overlapped area S results even if all the windows are reduced to their minimum display sizes (Wmin1, Wmin2, Wmin3) (or even if the reduced windows are moved), (refer to FIG. 7G).

The second determiner 623c determines, based on the specified areas of the three windows (patient ID display field P1, patient ID display field P2, and patient ID display field P3), whether or not overlaid display of the window W1 and/or window W2 and the window W3 is possible.

As a specific example, the second determiner 623c specifies the specified areas of the three windows (patient ID display field P1, patient ID display field P2, and patient ID display field P3). The second determiner 623c specifies patient ID display field P1 as the specified area for window W1, based on the table information T3. The second determiner 623c also specifies patient ID display field P2 as the specified area for window W2, based on the table information T3. The second determiner 623c also specifies patient ID display field P3 as the specified area for window W3, based on the table information T3.

The second determiner 623c then determines whether or not the patient ID display fields P1, P2, and P3 can be displayed on the display screen 63a if the three windows are reduced to their minimum display sizes (Wmin1, Wmin2, Wmin3). As a specific example, the second determiner 623c acquires the display areas that results if the three windows are reduced to their minimum display sizes (Wmin1, Wmin2, Wmin3), by executing image-processing such as edge-detection, and the second determiner specifies the remaining area of the display screen 63a as free area V6 (the area where the windows Wmin1, Wmin2, and Wmin3 are not displayed) (refer to FIG. 7G). The second determiner 623c then determines whether or not the sum of the sizes of the patient ID display fields P1, P2, and P3 is equal to or smaller than the free area V6 of the display screen 63a. If the sum of the sizes of the three patient ID display fields is equal to or smaller than the free area V6 of the display screen 63a, then the three patient ID display fields can be displayed in the free area V6 by displaying the three windows partially overlaid one over another (refer to FIG. 7H).

If the determination results in that the overlaid display is possible, then the second determiner 623c sends the determination result to the adjuster 623b.

The adjuster 623b adjusts the displaying conditions of at least one window so that the three patient ID display fields will be displayed at least on the display screen 63a. As a specific example, the adjuster 623b reduces the three windows to their minimum display sizes (Wmin1, Wmin2, Wmin3) and executes adjustment to move each of the windows so that the three patient ID display fields can be displayed. In addition, in this embodiment, the adjuster 623b executes adjustment, based on the table information T3, to lay window Wmin1 over windows Wmin2 and Wmin3 so that the information of the patient chart, which has the highest priority, will come frontward in the overlapped area S. The display controller 624 displays the windows Wmin1, Wmin2, and Wmin3 on the display screen 63a, which are partially overlaid one over another, based on the result of the adjustment by the adjuster 623b (refer to FIG. 7H).

The display controller 624 executes displaying control for the display 63. For example, the display controller 624 executes control to display medical images, diagnostic reports, and so on, which have been acquired with the acquirer 621, in windows of predetermined display sizes on the display 63. The display controller 624 is configured to include a thumbnail creator 624a.

### (Display)

The display 63 is a displaying device for respectively displaying windows for patient charts, diagnostic reports, medical images, and so on.

In the above-mentioned configuration, the first determiner 623a, the adjuster 623b, the second determiner 623c, the display controller 624, and the display 63 constitute an example of the “medical information displaying apparatus” as this embodiment.

### [Actions]

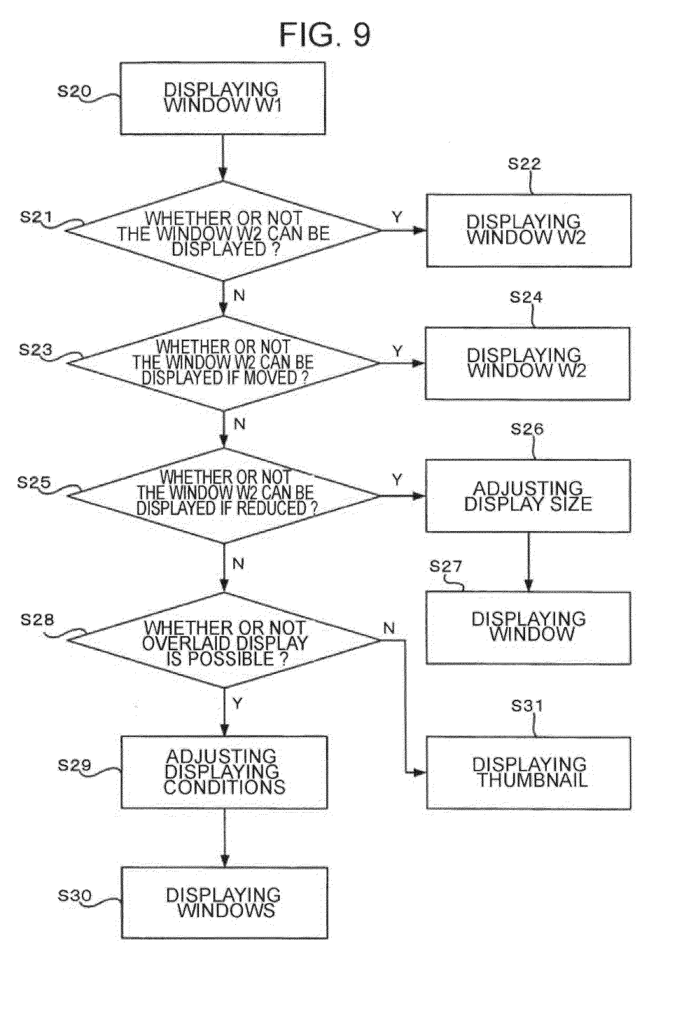

Now, actions taken by the electronic patient chart apparatus 6 as this embodiment are described with reference to FIG. 9.

At first, when the electronic patient chart apparatus 6 receives a patient ID input with the input unit 61, the acquirer 621 acquires a patient chart that relates to the patient ID from the medical information storage 8. The display controller 624 displays the obtained patient chart in a window (window W1) on the display screen 63a (S20).

In the state at S20, if an instruction is input with the input unit 61 to display a window W2 for blood test information, the first determiner 623a recognizes the display area of the window W1 by executing edge-detection on the display screen 63a and specifies the remaining area of the display screen 63a as free area V1. The first determiner 623a compares the displaying conditions predetermined for the window W2 for blood test information to the free area V1 and determines whether or not the window W2 can be displayed in the free area V1 (S21).

If the determination results in that the window W2 can be displayed in the free area V1, which has been specified at S21 (in the case of Y at S21), then the display controller 624 displays the window W2 in the free area V1 (S22).

On the other hand, if the determination results in that the window cannot be displayed in the free area V1 (in the case of N at S21), then the first determiner 623a specifies the size of another free area V2 that can result if the window W1 being displayed is moved on the display screen 63a, and the first determiner then determines whether or not the window W2 can be displayed in the free area V2 (S23).

If the determination results in that the window W2 can be displayed in the free area V2, which has been specified at S23 (in the case of Y at S23), then the display controller 624 moves window W1 and displays window W2 in the free area V2, which has resulted from the movement (S24).

On the other hand, if the determination results in that the window cannot be displayed in the free area V2 even if window W1 is shifted (in the case of N at S23), then the adjuster 623b determines whether or not the windows W1 and W2 can be displayed on the display screen 63a if each of the windows is reduced, based on the information of the minimum display sizes of the windows W1 and W2 (S25).

If the determination results in that the windows W1 and W2 can be displayed with reduction of the window display sizes (in the case of Y at S25), then the adjuster 623b specifies the window whose display size be changed, based on the priority order defined in the table information, and the adjuster adjusts the display size accordingly (S26). The display controller 624 displays the windows W1 and W2 in their display sizes, which have been adjusted at S26 (S27).

On the other hand, if the determination results in that the window W1 and window W2 cannot be displayed even if the windows are reduced to their minimum display sizes (in the case of N at S25), the adjuster 623b sends the determination result to the second determiner 623c.

The second determiner 623c specifies the above-mentioned specified areas (patient ID display fields P1 and P2), respectively, for the windows W1 and W2. The second determiner 623c then determines whether or not the patient ID display fields P1 and P2 can be displayed on the display screen 63a if the windows W1 and W2 are reduced to their minimum display sizes (Wmin1, Wmin2). In other words, the second determiner 623c determines whether or not overlaid display of the windows W1 and W2 is possible (S28).

If the determination results in that the overlaid display is possible (in the case of Y at S28), then the second determiner 623c sends the determination result to the adjuster 623b.

The adjuster 623b adjusts the displaying conditions of the window W1 and/or window W2 so that the patient ID display field P1 of window W1 and the patient ID display field P2 of window W2 will be displayed at least on the display screen 63a (S29). The display controller 624 displays the windows Wmin1 and Wmin2, which are partially overlaid one over the other, on the display screen 63a, based on the result of the adjustment done by the adjuster 623b (S30).

On the other hand, if the determination results in that the overlaid display is impossible (in the case of N at S28), then the thumbnail creator 624a thumbnails either one of the windows and displays it in connection with the other window on the display screen 63a (S31). Instead, it is also possible that the display controller 624 display a warning message that indicates the impossibility of displaying the window on the display screen 63a.

The above-mentioned configuration (the first determiner 623a, the adjuster 623b, the second determiner 623c, the display controller 624, and the display 63) can be provided in a report-generating apparatus 4, an image displaying apparatus 7, or the like. In this case, the above-discussed configuration provided in the report-generating apparatus 4 or the image displaying apparatus 7 is an example of the “medical information displaying apparatus”.

### [Operation and Effects]

The following description concerns the operation and effects of the medical information displaying apparatus as the second embodiment.

The medical information displaying apparatus comprises a display 63, a display controller 624, a first determiner 623a, an adjuster 623b, and a second determiner 623c. The display controller 624 causes the display 63 to display a plurality of windows, each of which has a predetermined display size, on the display screen 63a of the display 63. In the case where at least a first window is displayed on the display screen 63a, if a second window is to be additionally displayed on the display screen 63a, then the first determiner 623a determines, based on the display area of the first window, whether or not there is an area sufficient for displaying the second window on the display screen 63a in compliance with the displaying conditions of the second window. If the determination results in that no area sufficient for displaying the second window is available, then the adjuster 623b determines whether or not it is possible to make adjustment to the displaying conditions of the first window and/or the second window so that the first window and the second window will be displayed on the display screen 63a, and if the determination results in that the displaying conditions can be adjusted, then the adjuster adjusts the displaying conditions. If the determination results in that the displaying conditions cannot be adjusted, then the second determiner 623c determines whether or not overlaid display of the first window and the second window is possible, based on the specified area of the first window and the specified area of the second window. Furthermore, if the determination results in that the overlaid display possible, then the adjuster 623b adjusts the displaying conditions of the first window and/or second window so that the specified area of the first window and the specified area of the second window will be displayed at least on the display screen 63a.

The second determiner 623c determines whether or not overlaid display of the first window and the second window is possible, based on the specified area of the first window and the specified area of the second window. The adjuster 623b, then, automatically adjusts the displaying conditions of the first window and/or the second window so that the specified area of the first window and the specified area of the second window will be displayed at least on the display screen 63a. Therefore, there is no need of hand-operated adjustment of the display size or the like of the window every time when a new window is displayed. In addition, the specified area of the window can be displayed with certainty on the display screen 63a. As a result, efficiency can be improved in such work as interpreting medical images or performing diagnostic examination, which is performed with a plurality of windows being displayed on the display screen.

### Third Embodiment

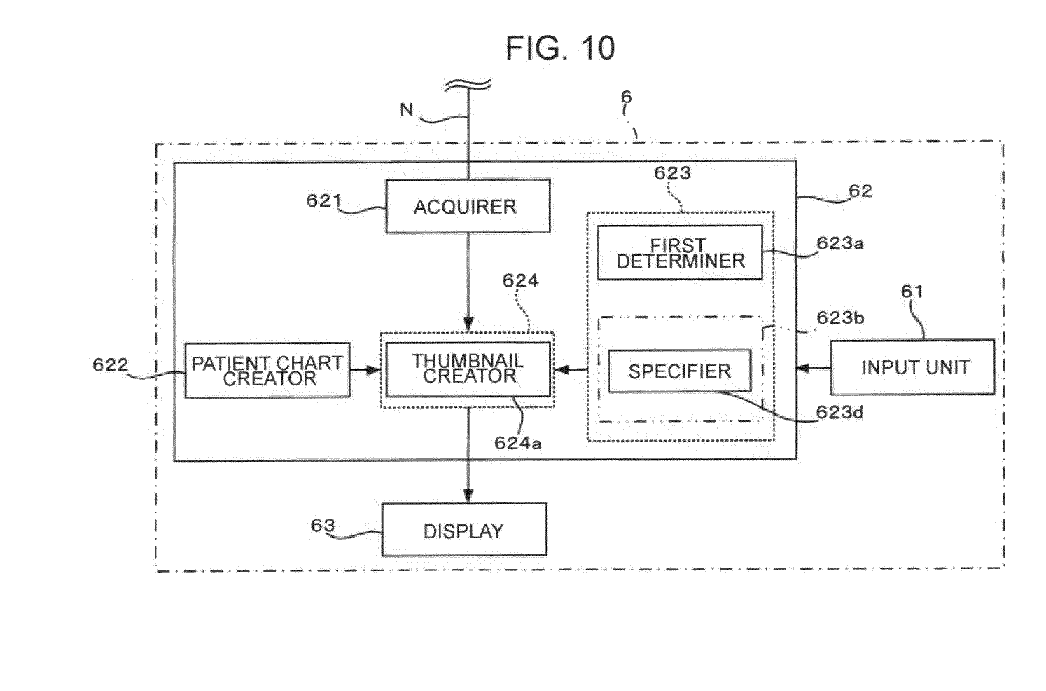

Now, the configuration of a medical information displaying apparatus (a part of the electronic patient chart apparatus 6) as a third embodiment is described with reference to FIG. 10 through FIG. 12. Detailed description may be left out of the parts of the configuration that are the same as the first or second embodiment.

This embodiment is to describe actions that result if the displaying conditions of some of the windows being displayed on the display screen are changed. Specific examples of changes made in the displaying conditions are “closing the window”, “adjusting the size and position of the window”, and so on.

### [Configuration of the Electronic Patient Chart Apparatus]

FIG. 10 is a block diagram showing the details of the electronic patient chart apparatus 6 as this embodiment. The electronic patient chart apparatus 6 is configured to include an input unit 61, a CPU 62, and a display 63 in the same way as the first embodiment. The CPU 62 functions as an acquirer 621, a patient chart creator 622, a processor 623, and a display controller 624 under the control of its dedicated application software. The processor 623 is configured to include a first determiner 623a and an adjuster 623b.

Here, the adjuster 623b in this embodiment is configured to include a specifier 623d.

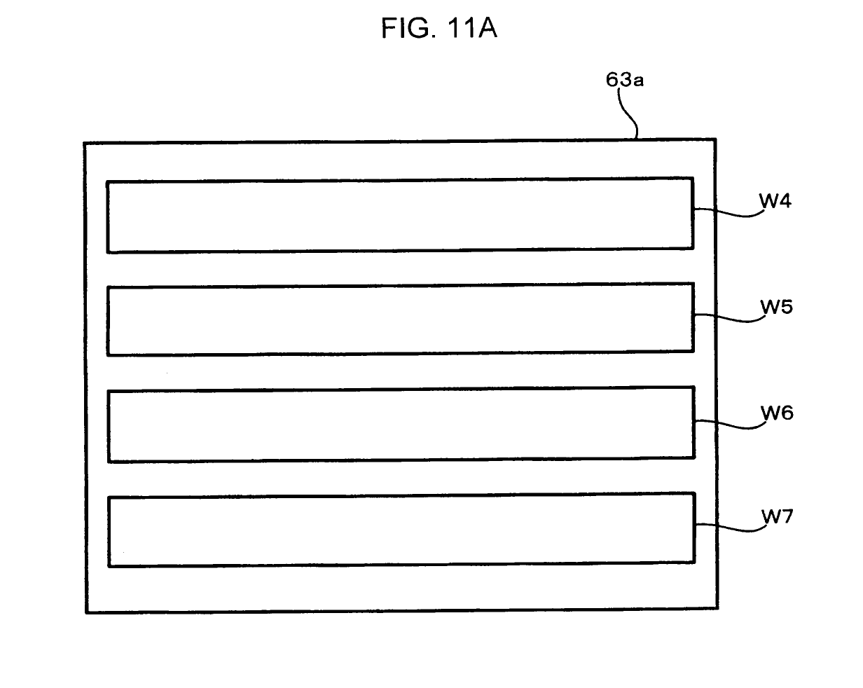

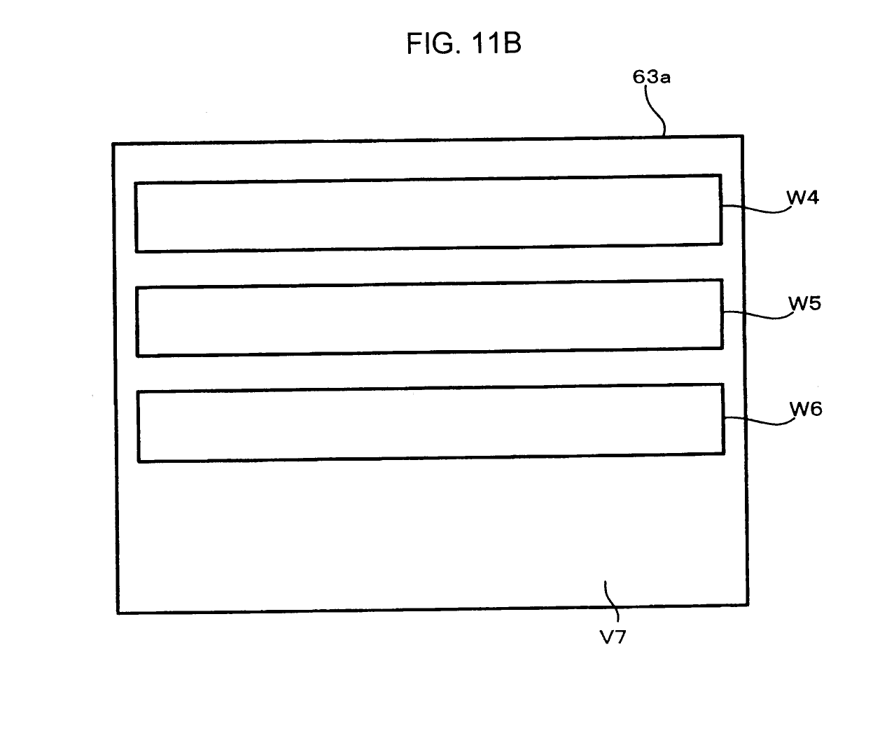

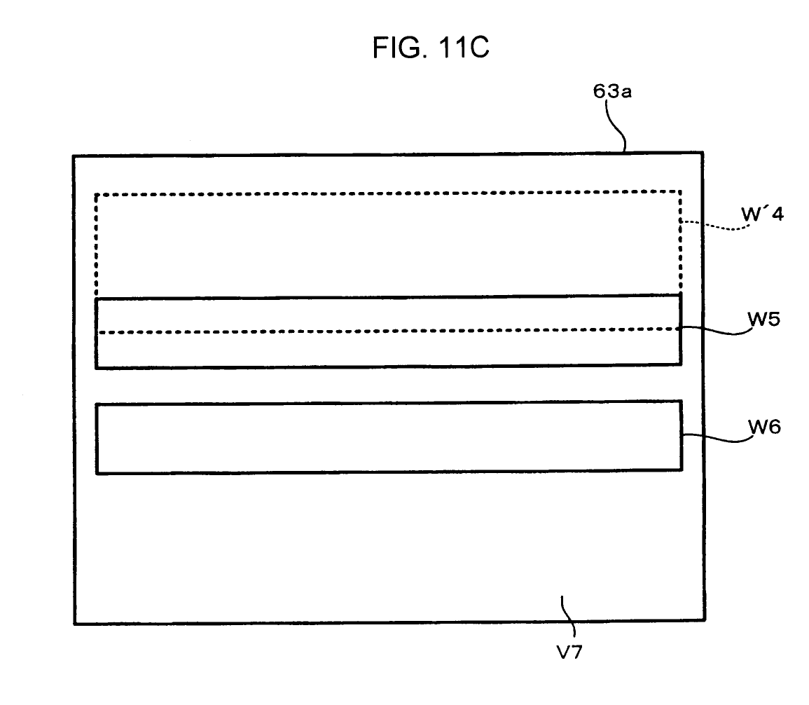

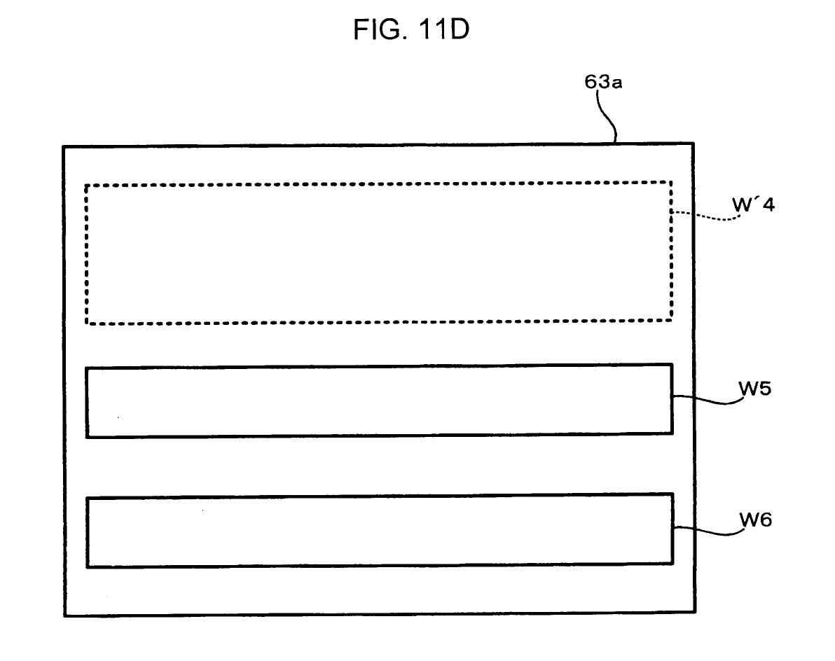

If the displaying conditions of the first window or the second window are changed, then the specifier 623d specifies an area where the first window or the second window is not displayed on the display screen 63a. The following specific example concerns a case where while a plurality of windows (window W4 through window W7) are being displayed on the display screen 63a (refer to FIG. 11A), window W7 is closed (refer to FIG. 11B). Upon detecting the closure of the window W7, the specifier 623d acquires the display areas of the remaining other windows (window W3 through window W6) by image-processing and specifies the remaining vacant area of the display screen 63a as free area V7 (the area where the windows W4 through W6 are not displayed) (refer to FIG. 11B).

The adjuster 623b then adjusts the displaying conditions of the first window or the second window, based on the result of the specification done by the specifier 623d. The following specific example concerns a case where the specifier 623d has specified the free area V7. In this case, the adjuster 623b adjusts the displaying conditions of the windows W4 through W6 for the free area V7. Which one of the windows takes first priority in the adjustment of the displaying conditions is determined, based on, for example, table information that defines a predetermined priority order. Instead, however, priority order may be determined each time, based on an instruction input with the input unit 61 or the like, and the adjustment may be executed accordingly. Here, for the sake of description, window W4 is assumed to have the highest priority. The adjuster 623b expands the window W4, which has the highest priority, only by the size of the area that had been occupied by window W7 (window W′4). On this occasion, if window W4 is expanded with the windows being placed as shown in FIG. 11B, then the part expanded of window W4 will overlap with window W5 (refer to FIG. 11C). The adjuster 623b, therefore, executes adjustment to move windows W5 and W6 on the display screen 63a. The display controller 624 displays the windows W′4 through W6, which have been adjusted by the adjuster 623b, on the display screen 63a (refer to FIG. 11D).

### [Actions]

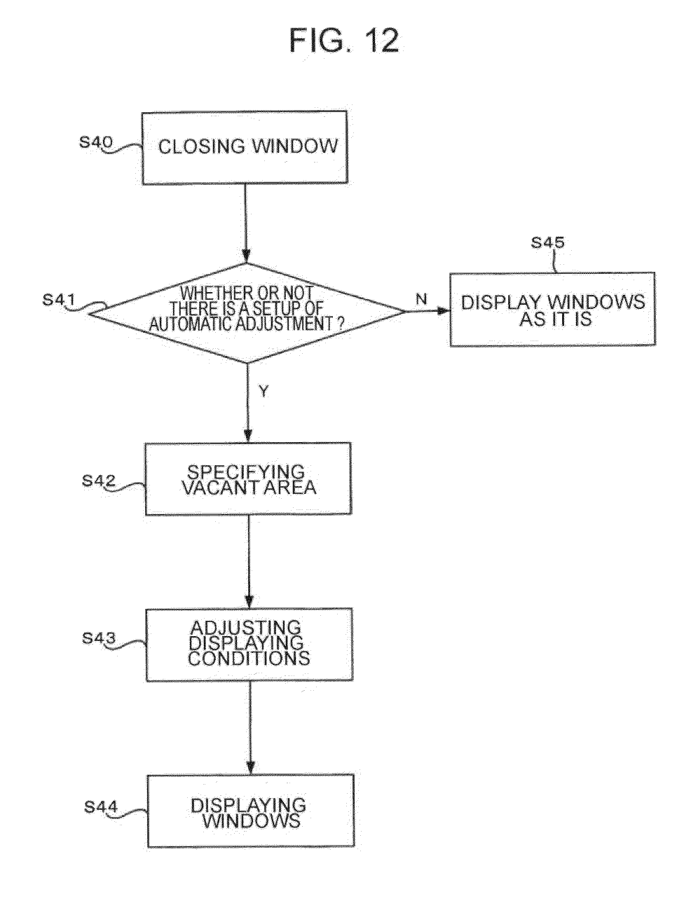

Now, actions taken by the electronic patient chart apparatus 6 as this embodiment are described with reference to FIG. 12.

While a plurality of windows (windows W4 through W7) are being displayed on the display screen 63a, if an instruction is input with the input unit 61 or the like to close a window W7, the display controller 624 closes the window W7 (S40).

After the window W7 is closed, the adjuster 623b determines whether or not there is a setup of automatically executing displaying-condition adjustment for the other remaining windows (S41).

In the case where there is a setup of automatic adjustment (in the case of Y at S41), if the specifier 623d detects that a window W7 has been closed, then the specifier acquires the display areas of the remaining windows (windows W3 through W6) by image-processing. The specifier 623d then specifies the area other than the display areas acquired of the display screen 63a as free area V7 (the area where windows W4 through W6 are not displayed) (S42).

The adjuster 623b then adjusts the displaying conditions of the windows W4 through W6 for the free area V7 (S43). The adjuster 623b expands window W4, which has the highest priority, only by the size of the area that had been occupied by window W7 (window W′4). The adjuster 623b also executes adjustment to move windows W5 and W6 on the display screen 63a.

The display controller 624 displays the windows W′4 through W6, which have been adjusted by the adjuster 623b, on the display screen 63a (S44).

On the other hand, in the case where there isn't any setup of automatic adjustment (in the case of N at S41), the display controller 624 continues to display the windows W4 through W6 as in the state where window W7 has been closed (S45).

The above-mentioned configuration (the adjuster 623b and the specifier 623d) can be provided in the report-generating apparatus 4, the image displaying apparatus 7, or the like. In this case, the above-discussed configuration provided in the report-generating apparatus 4 or the image displaying apparatus 7 is an example of the “medical information displaying apparatus”.

### [Operation and Effects]

The following description concerns the operation and effects of the medical information displaying apparatus as the third embodiment.

The adjuster 623b of the medical information displaying apparatus includes a specifier 623d. If the displaying conditions of a first window or a second window are changed, then the specifier 623d specifies an area where the first window or the second window is not displayed on the display screen 63a. The adjuster 623b then adjusts the displaying conditions of the first window or the second window, based on the result of the specification done by the specifier 623d. The display controller 624 then displays the first window or the second window on the display screen 63a, as has been adjusted by the adjuster 623b.

In this way, according to the medical information displaying apparatus as this embodiment, when changes are made in the displaying conditions of a window, the display sizes and the like of other windows can be automatically adjusted. As a result, efficiency can be improved in such work as interpreting medical images or performing diagnostic examination, which is performed with a plurality of windows being displayed on the display screen.

### Fourth Embodiment

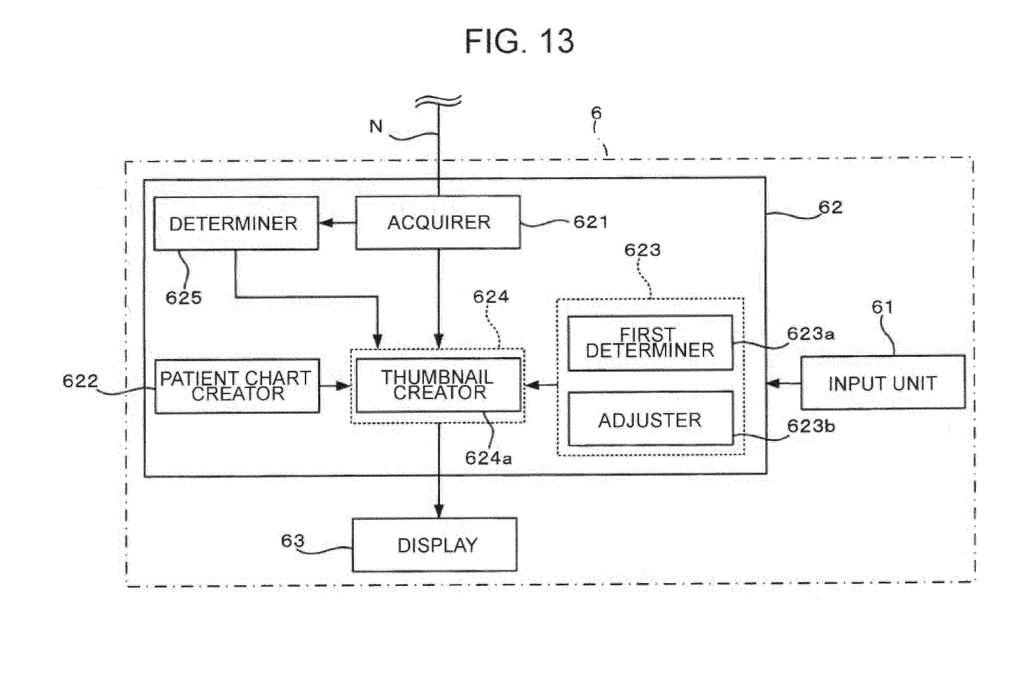

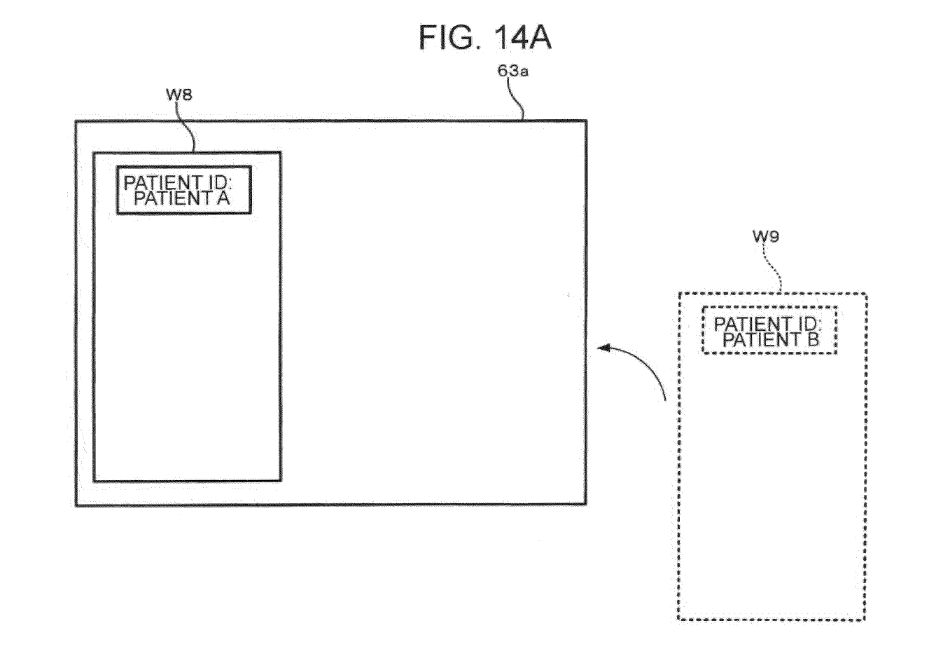

Now, the configuration of a medical information displaying apparatus (a part of the electronic patient chart apparatus 6) as a fourth embodiment is described with reference to FIG. 13 through FIG. 15. Detailed description may be omitted of the parts of the configuration that are similar to the first through third embodiments.

A physician or the like performs creation of patient charts for a plurality of patients, on one terminal. In creation of a patient chart or the like, he or she displays a plurality of windows on the display screen. In such a case, after the completion of the creation of a patient chart for a certain patient, if another patient chart is to be created for a next patient, normally, all the windows showing information of the previous patient are closed before windows showing information of the next patient are opened. There is, however, the possibility that some windows may be unintentionally left unclosed in a case where the windows showing information of the previous patient are to be closed manually.

This embodiment realizes a configuration that prevents such windows from being left unclosed unintentionally and that can improve efficiency in such work as medical image interpretation or diagnostic examination, which is performed with a plurality of windows being displayed on the display screen.

### [Configuration of the Electronic Patient Chart Apparatus]

FIG. 13 is a block diagram showing the details of an electronic patient chart apparatus 6 as this embodiment. The electronic patient chart apparatus 6 is configured to include an input unit 61, a CPU 62, and a display 63 in the same way as the first embodiment, and so on. The CPU 62 functions as an acquirer 621, a patient chart creator 622, a processor 623, a display controller 624, and a determiner 625 under the control of its dedicated application software. The processor 623 is further configured to include a first determiner 623a and an adjuster 623b.

While a first window is being displayed on the display screen 63a, if a second window is to be displayed on the display screen 63a, then the determiner 625 determines whether or not the identification information associated with the first window and the identification information associated with the second window differ from each other.

The identification information here means information that indicates that a certain window relates to other windows, and the identification information can be, for example, patient ID.

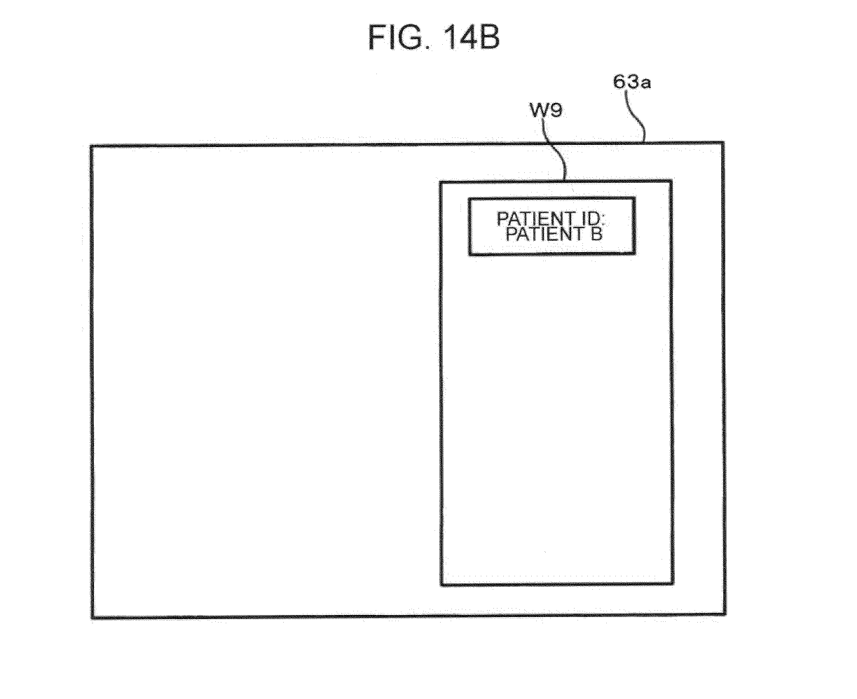

The following specific example describes a case where while a window W8 is being displayed as a first window on the display screen 63a (refer to FIG. 14A), in response to an instruction input with the input unit 61 or the like, another window W9 is to be displayed as a second window on the display screen 63a. In this case, the determiner 625 determines whether or not the patient ID associated with window W8 and the patient ID associated with window W9 indicate the same patient.

If the determination by the determiner 625 results in that the patient IDs are different (e.g., while the ID of window W8 indicates patient A, the ID of window W9 indicates patient B as shown in FIG. 14A), for example, the display controller 624 displays a warning that indicates that the patient IDs are different on the display screen 63a. After that, if an instruction is input with the input unit 61 to close window W8, then the display controller 624 terminates the displaying of window W8 and displays window W9 on the display screen 63a (refer to FIG. 14B). It is desirable that this process be executed for each window in a case where a plurality of windows are displayed sequentially. Incidentally, instead of displaying the warning if the patient IDs are different, the display controller 624 can display either of the windows in a changed display position or display size. If the displaying conditions of the windows are changed in this way, then the physician or the like can easily recognize that the displayed window is of a different patient.

### [Actions]

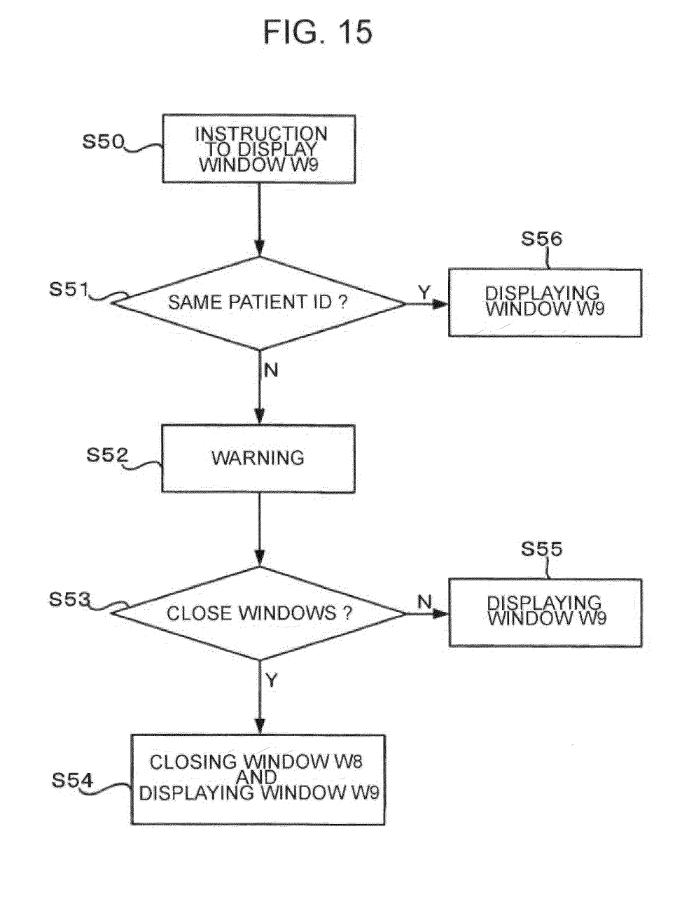

Now, actions taken by the electronic patient chart apparatus 6 as this embodiment are described with reference to FIG. 15.

At first, while a window W8 is being displayed on the display screen 63a, if an instruction is input with the input unit 61 or the like to display a new window W9 (S50).

The determiner 625 determines whether or not the patient ID associated with window W8 and the patient ID associated with window W9 indicate the same patient (S51).

If the determination by the determiner 625 results in that the patient IDs are different (in the case of N at S51), the display controller 624 displays a warning indicating that the patient IDs are different, on the display screen 63a (S52). In response to the warning, the physician or the like can determine whether or not either of the windows should be closed (S53).

If an instruction is input with the input unit 61 to close window W8 (in the case of Y at S53), then the display controller 624 terminates the displaying of window W8 and displays window W9 on the display screen 63a (S54). On the contrary, if an instruction is input with the input unit 61 not to close the window W8 (in the case of N at S53), then the display controller 624, while keeping window W8, displays window W9, which is associated with a different patient ID (S55).

On the other hand, if the determination by the determiner 625 results in that the patient IDs are the same (in the case of Y at S51), then the display controller 624 displays the window W8 and window W9 on the display screen 63a (S56). At this instant, for example, the process of the first embodiment can be executed to display the windows W8 and W9 in adjusted displaying conditions on the display screen 63a.

The above-mentioned configuration (the determiner 625 and the display controller 624) can be provide in the report-generating apparatus 4, the image displaying apparatus 7, and so on. In this case, the above-discussed configuration provided in the report-generating apparatus 4 or the image displaying apparatus 7 is an example of the “medical information displaying apparatus”.

### [Operation and Effects]

The following description concerns the operation and effects of the medical information displaying apparatus as the fourth embodiment.

The medical information displaying apparatus further comprises a determiner 625. While a first window is being displayed on the display screen 63a, if a second window is to be displayed on the display screen 63a, then the determiner 625 determines whether or not the identification information associated with the first window and the identification information associated with the second window differ from each other. If the determination results in that the identification information is different, then the display controller 624 terminates the displaying of the first window and displays the second window.

If the instruction is to display a window associated with different identification information like a different patient ID, then the window being displayed as the first is closed, preventing the window from being left unclosed unintentionally. As a result, efficiency can be improved in such work as interpreting medical images or performing diagnostic examination, which is performed with a plurality of windows being displayed on the display screen.

### <Effects Common to the Embodiments>

According to the configuration of at least one of the embodiments described above, the first determiner 623a determines whether or not there is an area sufficient for displaying a second window on the display screen 63a, based on the display area of the first window and in compliance with the displaying conditions of the second window. The adjuster 623b, then, automatically adjusts the displaying conditions of the first window and/or the second window so that the first window and the second window will be displayed on the display screen 63a. Therefore, there is no need of hand-operated adjustment of the window display size, and so on, every time when a new window is displayed. As a result, efficiency can be improved in such work as interpreting medical images or performing diagnostic examination, which is performed with a plurality of windows being displayed on the display screen.

### Fifth Embodiment

The first through fourth embodiments, which have been described above, are to adjust the displaying conditions of the first and second windows so that the areas of the respective windows can be effectively displayed. As a result, the medical information shown in the display areas is readily recognized, improving efficiency in such work as image interpretation and diagnostic examination. The “displaying conditions” include window display size, display format, display position, and opening and closing of the window.

Improving the recognition of the medical information displayed is, however, not limited to adjusting the displaying conditions of the respective windows. For example, along with the adjustment of the displaying conditions of the window, or independently of the adjustment, the position of all or part of the medical information displayed in the display areas may be adjusted.

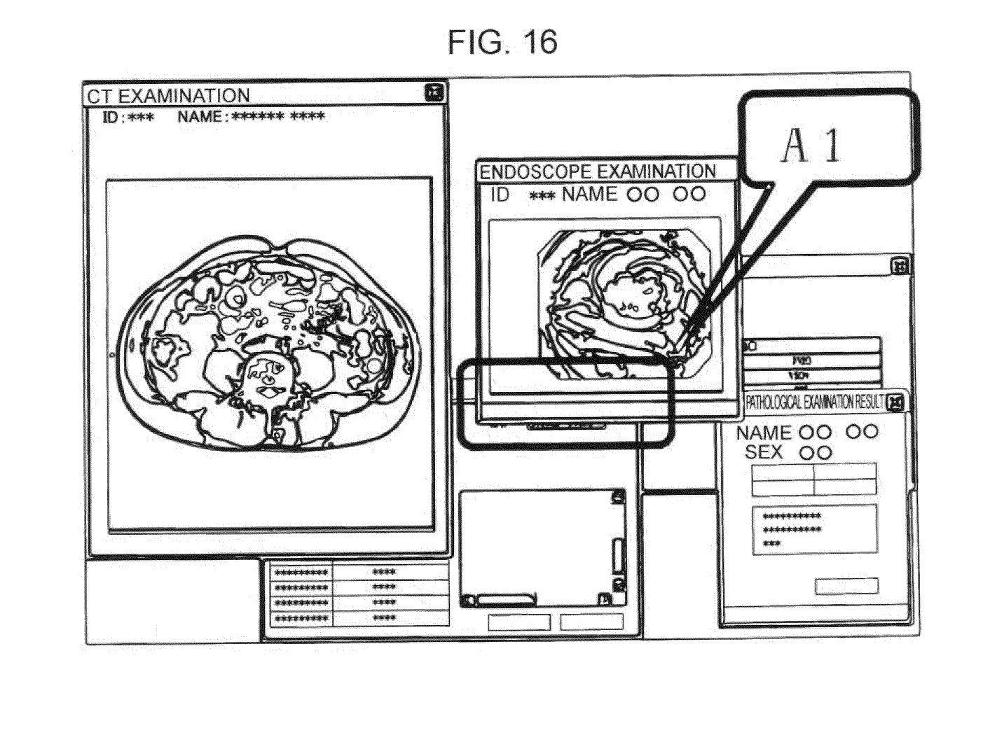

Now, the configuration of a medical information displaying apparatus (a part of the electronic patient chart apparatus 6) as a fifth embodiment is described with reference to FIG. 16 through FIG. 18. Detailed description may be omitted of the parts of the configuration that are the same as the first through fourth embodiments.

In the first embodiment, which has been described, an overlapped area (referred to also as “overlaid display”) can result from, for example, a first window and a second window being overlaid one over the other. If this happens, the medical information shown in the overlapped areas will be hard to be noticed. At such an instant, the second determiner 623c determines that the overlaid display is not possible. If the determination results in that the overlaid display is not possible, then the adjuster 623b reduces each of the windows into its minimum display size by referring to the information of the minimum display sizes. For example, the adjuster 623b executes adjustment to reduce the window for blood test information and the window for pathological examination information such that both will have the same size. The display controller 624 displays the window for blood test information and the window for pathological examination information on the display screen, based on the result of the adjustment done by the adjuster 623b.

### (Adjuster and Display Controller)

In the fifth embodiment, the adjuster 623b, if the determination results in that the overlaid display is impossible, adjusts the position of all or part of the medical information displayed in the display area of at least either of the display areas of the first and second windows.

The display controller 624 displays, on the display screen, the medical information all or part of which has been positionally adjusted by the adjuster 623b. Here, the term “part of the medical information” means an extract that has been taken from a piece of medical information originally defined to be displayed in the display area, the extraction being based on a predetermined condition. Furthermore, the “position of all or part of the medical information” may be simply stated “position of the medical information”.

Here, the “predetermined condition” is defined by, for example, priority that is predetermined for the medical information, and table information for a predetermined order of priority is stored in a storage (not shown). When the position of the medical information is adjusted by the adjuster 623b, the table information is read out from the storage.

Furthermore, the adjuster 623b adjusts the position of the medical information along with the adjustment of the window display size. Here, the “window display size” includes a specifically defined display size in addition to a display size predetermined for the window. The “specifically defined display size” is generated in correspondence with, for example, the size and form of a free area on the display screen. Furthermore, the adjuster 623b adjusts the position of the medical information so as to make the medical information readily recognizable.

### [Actions]

Now, actions taken by the medical information displaying apparatus as this embodiment are described with reference to FIG. 16 through FIG. 18.

FIG. 16 is a drawing showing an example of overlaid display. FIG. 16 shows a case of overlaid display where the “full name of the patient”, which is part of the medical information, is not viewable because the window for endoscopy information and the window for diagnostic report are overlapped in display area. In FIG. 16, the “area incapable of showing medical information” is marked with “A1”.

In such a case, the second determiner 623c determines that the overlaid display is not possible. If the determination is that the overlaid display is impossible, then the adjuster 623b adjusts the position of the medical information along with the adjustment of the window display sizes.

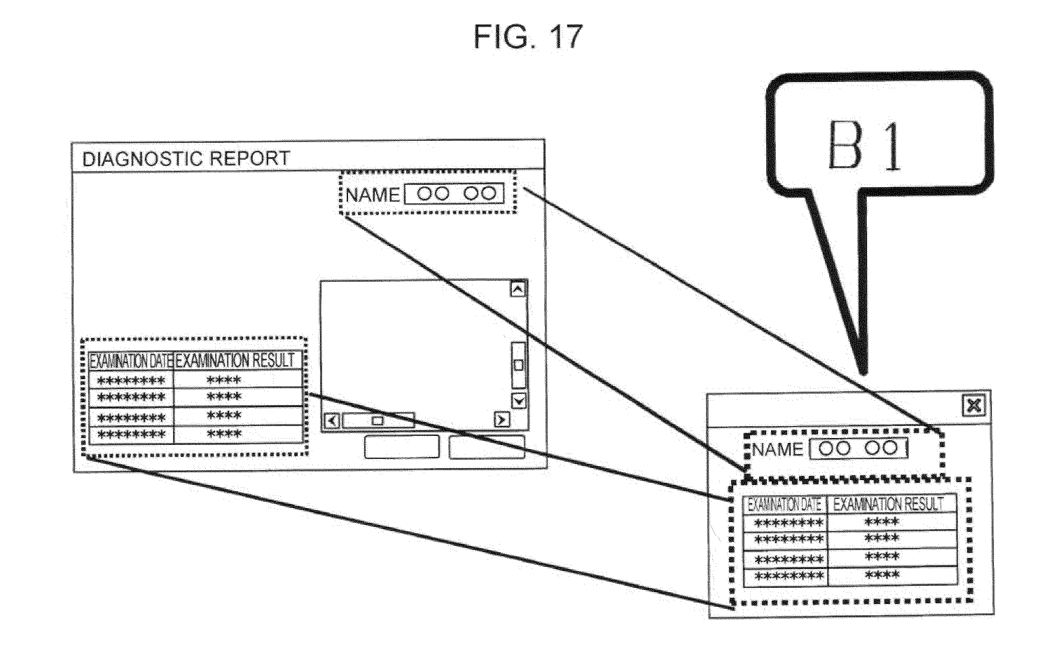

FIG. 17 is a drawing showing an example of a display size for a window that corresponds to a vacant area of the display screen, with medical information to be moved into the window.

The free area on the display screen shown in FIG. 17 is an area surrounded by a window for endoscopy information, a window for CT examination information, and a window for pathological examination information.

The adjuster 623b determines the display size for a window that corresponds to the vacant area on the display screen and also determines the part of the medical information to be moved into the window, which information is, in this case, the full name of a patient and his or her test results (including the test date). The display size and the part of the medical information determined in this way are the results of the adjustment made by the adjuster 623b. FIG. 17 shows “a new window with inline frames, which is made as a substitute” and is indicated with “B1”.

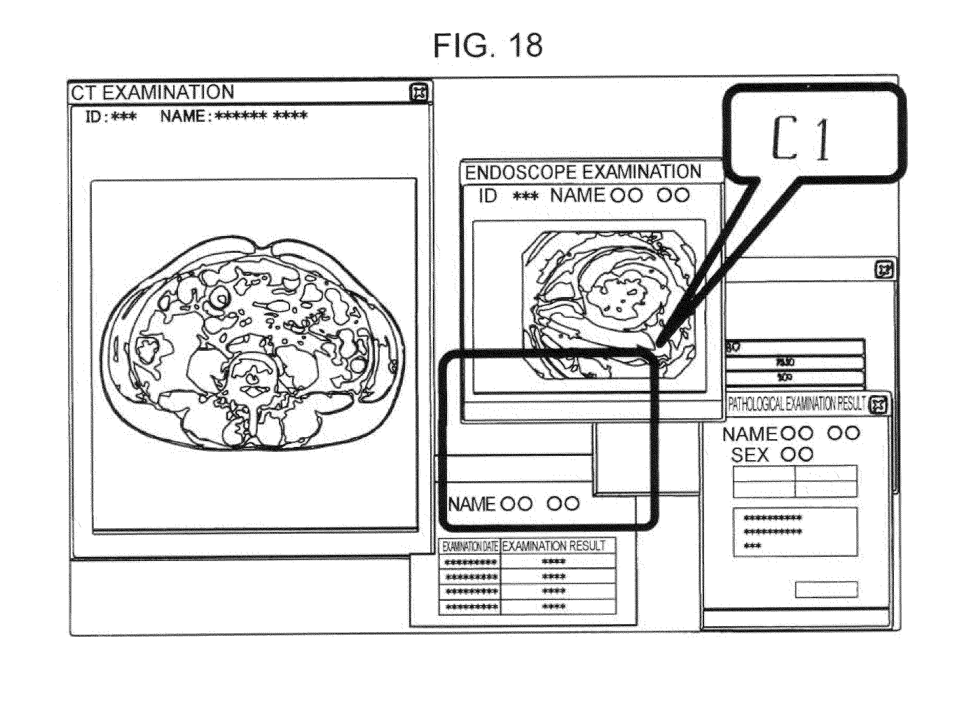

FIG. 18 is a drawing showing an example of a window displayed in a vacant area of the display screen and the medical information displayed in the display area of the window.

As shown in FIG. 18, the display controller 624 displays part of the medical information on the display screen, based on the result of the adjustment by the adjuster 623b. As a result, the full name of the patient and the test results are now recognizable in the window for diagnostic report. Accordingly, efficiency can be improved in such work as medical image interpretation or diagnostic examination. FIG. 18 shows the “area that has come capable of displaying medical information”, which is indicated with “C1”.

By the way, this embodiment has been presented with the adjuster 623b that adjusts the position of the medical information along with the adjustment of the window display size. However, the adjuster 623b may adjust the position of the medical information independently of the adjustment of the window display size. Furthermore, in the above embodiment, the adjuster 623b changes the position of part of the medical information. However, the adjuster may change the position of all the medical information.

The embodiments of the present invention were set forth; however, the embodiments described above were presented as examples and are not intended to limit the range of the invention. These new embodiments may be carried out in various other configurations, and various abbreviations, replacements, and changes may be made in a range not departing from the summary of the invention. These embodiments and deformations thereof are included in the range and summary of the invention and included in the invention described in the range of patent claims as well as the range of the equivalent thereof.

1. A medical information displaying apparatus comprising:
a display;
a display controller configured to display, on a display screen of the display, a plurality of windows, each of which has a predetermined display size;
a first determiner configured to determine, with at least a first window having been displayed on the display screen and if a second window is to be additionally displayed on the display screen, whether or not there is an area for displaying the second window on the display screen, based on a display area for the first window and in compliance with displaying conditions for the second window;
an adjuster configured to determine, in response to the determination having resulted in that no area is available for displaying the second window, whether or not it is possible to make adjustment to the displaying conditions of the first window and/or the second window so that the first window and the second window will be displayed on the display screen, the adjuster also configured to adjust the displaying conditions if the determination has resulted in that the displaying conditions can be adjusted; and
a second determiner configured to determine, in response to the determination having resulted in that the displaying conditions cannot be adjusted, whether or not overlaid display of the first window and second window is possible, based on a specified area for the first window and a specified area for the second window;
wherein the adjuster adjusts, in response to the determination having resulted in that the overlaid display is impossible, the display sizes of the first window and the second window in accordance with a minimum display size for each of the first window and/or the second window so that the specified area of the first window and the specified area of the second window will be displayed at least on the display screen.

2. A medical information displaying apparatus according to claim 1, wherein in response to the determination having resulted in that the displaying conditions of the windows cannot be adjusted, the display controller thumbnails the first window and/or the second window.

3. A medical information displaying apparatus according to claim 2, wherein in response to the determination having resulted in that the overlaid display is impossible, the display controller thumbnails the first window and/or the second window.

4. A medical information displaying apparatus according to claim 1, wherein the minimum display size is a display size for the whole of a minimized window that still allows the medical information shown in the window recognizable.

5. A medical information displaying apparatus according to claim 1, wherein the minimum display size is determined based on the size of a medical image to be displayed in each of the first and second windows.

6. A medical information displaying apparatus according to claim 4, wherein the size of a medical image is determined based on the size of an attention region of the medical image, to which an annotation is added.

7. A medical information displaying apparatus according to claim 1, wherein the adjuster adjusts the display sizes of the first window and the second window, based on the display size in which each of the first window and/or second window has displayed in times past.

8. A medical information displaying apparatus according to claim 4, wherein the adjuster selects a window whose display size is to be adjusted, based on a predetermined priority, and the adjuster adjusts the display size.

9. A medical information displaying apparatus according to claim 4, wherein the adjuster adjusts display positions for the first window and/or the second window on the display screen as the displaying conditions, in addition to the display sizes.

10. A medical information displaying apparatus according to claim 1, wherein
the adjuster comprises a specifier configured to specify, when the displaying conditions of the first window or the second window are changed, an area where the first window or the second window is not displayed on the display screen;
the adjuster adjusts the displaying conditions of the first window or the second window, based on the result of the specification by the specifier; and
the display controller displays the first window or the second window that has been adjusted by the adjuster on the display screen.

11. A medical information displaying apparatus according to claim 1, further comprising
a determiner configured to determine, when the second window is to be displayed on the display screen with the first window being displayed on the display screen, whether or not identification information associated with the first window and identification information associated with the second window differ from each other;
wherein
if the determination has resulted in that the identification information differs, then the display controller terminates displaying the first window and displays the second window.

12. A medical information displaying apparatus according to claim 8, wherein the priority is determined for respective specialties of a hospital.

13. A medical information displaying apparatus according to claim 12, wherein a window for patient chart is set as the priority for a clinical department of the hospital, and a window for examination image is set as the priority for a radiology department.

14. A medical information displaying apparatus comprising:
a display;
a display controller configured to display, on a display screen of the display, a plurality of windows having display areas, where medical information is shown;
a first determiner configured to determine, with at least a first window having been displayed on the display screen and if a second window is to be additionally displayed on the display screen, whether or not there is an area for displaying the second window on the display screen, based on a display area for the first window and in compliance with displaying conditions for the second window;
an adjuster configured to determine, in response to the determination having resulted in that no area is available for displaying the second window, whether or not it is possible to make adjustment to the displaying conditions of the first window and/or the second window so that the first window and the second window will be displayed on the display screen, the adjuster also configured to adjust the displaying conditions if the determination has resulted in that the displaying conditions can be adjusted; and
a second determiner configured to determine, in response to the determination having resulted in that the displaying conditions cannot be adjusted, whether or not overlaid display of the first window and the second window is possible, based on the display area of the first window and the display area of the second window;
wherein in response to the determination having resulted in that the overlaid display is impossible, the adjuster adjusts position of all or part of the medical information shown in at least one of the display areas.

15. A medical information displaying apparatus according to claim 14, wherein the adjuster adjusts the position of all or part of the medical information along with or independent from the adjustment of the display sizes of the first window and the second window.

16. A medical information displaying apparatus according to claim 14, wherein the adjuster adjusts the position of all or part of the medical information to make the medical information recognizable.

17. A medical information displaying apparatus according to claim 5, wherein the size of a medical image is determined based on the size of an attention region of the medical image, to which an annotation is added.

18. A medical information displaying apparatus according to claim 5, wherein the adjuster selects a window whose display size is to be adjusted, based on a predetermined priority, and the adjuster adjusts the display size.

19. A medical information displaying apparatus according to claim 6, wherein the adjuster selects a window whose display size is to be adjusted, based on a predetermined priority, and the adjuster adjusts the display size.

20. A medical information displaying apparatus according to claim 7, wherein the adjuster selects a window whose display size is to be adjusted, based on a predetermined priority, and the adjuster adjusts the display size.

21. A medical information displaying apparatus according to claim 15, wherein the adjuster adjusts the position of all or part of the medical information to make the medical information recognizable.
